(19) United States
(12) Patent Application Publication
(10) Pub. No.: US 2006/0122861 A1
(43) Pub. Date: Jun. 8, 2006

(54) Corporate introduction system and method

(76) Inventors: Michael R. Scott, San Diego, CA (US); Errol Leighton, San Diego, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/293,784

(22) Filed: Dec. 2, 2005

Related U.S. Application Data
(60) Provisional application No. 60/632,926, filed on Dec. 2, 2004.

(51) Int. Cl. G06Q 99/00

(52) U.S. Cl. 705/1

(57) ABSTRACT

Corporate introductions are based on data on event attendees, with whom introductions will be made. From the information relating to attendees, a group of sponsors is identified and a schedule of introductions at a corporate introduction event is produced. Dynamic scheduling and introduction changes can be implemented at the event, thereby increasing the likelihood of meaningful introductions.

### REFERENCE TO PRIORITY DOCUMENT

This application claims priority to pending U.S. Provisional Application Ser. No. 60/632,926 filed Dec. 2, 2004 by Michael Scott and Errol Leighton entitled “Corporate Introduction System and Method”, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Business-to-business introductions are an important part of commerce and are important for corporate relations, marketing, and for furthering sales. Corporate introduction services, sometimes referred to as “corporate matchmaking”, is an expanding business. Such services go beyond arranging presentations at trade shows or participating in industry support groups.

For example, some companies currently involved in corporate matchmaking activities include: Richmond Events Ltd. of London, England; marcus evans Group of London, England; and World Trade Group of London, England. Generally, corporate matchmaking services involve obtaining sponsors for an event, then recruiting attendees for the event, at which introductions will take place. The events are typically oriented toward initiating introductions of sponsors to attendees, thereby securing audiences that might otherwise not take place.

Although corporate introductions can be helpful, such introduction events can have shortcomings. For example, one cannot be assured that appropriate persons (decision makers) will be in attendance or will be interested. The information available to event matchmakers from sponsors and attendees might be faulty, resulting in introductions that are not fruitful.

It would be helpful if corporate matchmaking services were more likely to bring together important decision makers who have a genuine interest in introductions that is mutually shared between the companies and individuals being introduced. The present invention provides such services.

### SUMMARY

The present invention provides corporate introductions that are based on first obtaining data on event attendees, with whom introductions will be made. From the information relating to attendees, a group of sponsors is identified and introductions are arranged. The attendee information preferably includes information about business relationship information that would be of mutual interest, such as supply needs, purchasing decisions, and marketing plans. The attendee information, and corresponding sponsor information, can be obtained from carefully crafted survey techniques. The introductions that take place during the planned event are arranged according to attendee information and corresponding sponsor information, to increase the likelihood of meaningful introductions. As introductions are made at an event, plans and interests of all participants at the event can change as new leads are obtained and new information is received. In accordance with the invention, dynamic scheduling and introduction changes are supported, thereby increasing the likelihood of meaningful introductions. Such changes are preferably implemented in special software applications that can be implemented on mobile devices, such as Personal Digital Assistants (PDAs), that facilitate dynamic scheduling and prompt information interchange among participants at an event to ensure introductions that provide an appropriate return on investment for all concerned.

Thus, a corporate introduction event is promoted, wherein introductions are supported by obtaining attendee information data relating to a set of event attendees, the attendee information data and a set of sponsor information data is processed to produce a set of introduction meetings between attendees and sponsors to take place the event, and a schedule of meetings between participants at the event is created, wherein the event participants include event attendees and event sponsors, such that each participant can receive real time schedule changes.

Additional details are provided below, which further explain embodiments in accordance with the invention for marketplace driven corporate introductions.

Other features and advantages of the present invention should be apparent from the following description of the preferred embodiment, which illustrates, by way of example, principles of the invention.

### BRIEF DESCRIPTION OF DRAWINGS

FIG. 1 is a block diagram that shows the general system design.

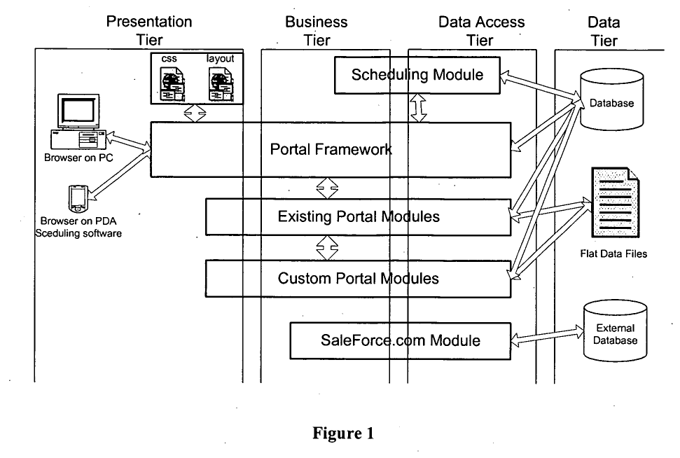

FIG. 2 is a flow diagram that illustrates event registration and scheduling workflow, including the event status at each stage.

FIG. 3 is a block diagram of the Vishnu Desktop Scheduler module.

FIG. 4 is a data mapping table that shows how data fields are mapped from Salesforce.com to the Corporate Connections application.

FIG. 5 is a System Deployment diagram that shows the relation between the web components and the sql database.

FIG. 6 shows a Scheduling scenario with how an administrator would interact with the system and the experience a user would have.

FIG. 7 shows Salesforce.com integration with the system and how information is transferred back and forth between the two.

FIG. 8 shows Process Overview Schedule Generation diagram that shows the flow of the system and how an administrator is able to generate a schedule and the checks in place to ensure accuracy.

FIG. 9 shows the CorpConn Portal and the different levels of administrators and what their roles are.

FIG. 10 shows Roles Grid that simplifies the User Roles Table 1 and explains which user groups access the system and at what level.

FIG. 11 shows the Corporate Connections Portal Site Map that shows the website layout or map in relation to the home page. It shows how pages are grouped together and how they are navigated.

FIG. 12 shows the Invited Decision Maker Logon Workflow that shows how invited decision makers are handled at login.

FIG. 13 shows the Unconfirmed Sponsor Logon Workflow that shows how an unconfirmed (non-member) sponsor access the site. Note that they will be viewing marketing versions of portals, encouraging them to become a paid member.

FIG. 14 shows the Member Logon Workflow that shows what a decision maker will see versus a sponsor when logging into the site.

FIG. 15 is a screen shot that provides a Layout Sample showing the basic setup of information and how it will be displayed on the page, regardless of who signs in.

FIG. 16 is a screen shot of the portal page, showing the Event Setup Control display.

FIG. 17 is a screen shot of the portal page, showing the Agenda Edit Control display.

FIG. 18 is a screen shot of the portal page, showing the Sponsor Meeting Request Control display.

FIG. 19 is a screen shot of the portal page, showing the Agenda Confirmation Control display.

FIG. 20 is a screen shot of the portal page, showing the Schedule Import/Export Control display.

FIG. 21 is a screen shot of the portal page, showing the Round Table Administration Control display.

FIG. 22 is a screen shot of the portal page showing the Dinner Table Meeting Admin Control display.

FIG. 23 is a screen shot of the portal page, showing the Schedule Administration Control display.

FIG. 24 is a screen shot of the portal page, showing the Schedule View Control display.

FIG. 25 is a screen shot of the portal page, showing the Salesforce.com—Setup display.

FIG. 26 is a screen shot of the portal page, showing the Salesforce.com—Accounts to Orgs display.

FIG. 27 is a screen shot of the portal page, showing the Contacts to Users display.

FIG. 28 is a screen shot of the portal page, showing the Salesforce.com—Reconcile Contacts to Users display.

FIG. 29 is a screen shot of the portal page, showing the Salesforce.com—Reconcile Accounts to Orgs display.

FIG. 30 is a screen shot of the portal page, showing the Salesforce—Contact to Users—Detailed display.

FIG. 31 is a screen shot of the portal page, showing the Accounts to Orgs—Detailed display.

FIG. 32 is a screen shot of the portal page, showing the Admin—User and Org Bios display.

FIG. 33 is a screen shot of the portal page, showing the Admin—Bio Edit display.

FIG. 34 is a screen shot of the portal page, showing the Admin—Surveys display.

FIG. 35 is a screen shot of the portal page, showing the Admin—Survey Edit display.

FIG. 36 is a screen shot of the portal page, showing the Admin—Sponsor Details display.

FIG. 37 is a screen shot of the portal page, showing the Sponsor—Admin display.

FIG. 38 is a screen shot of the portal page, showing the Sponsor—Event Admin display.

FIG. 39 is a data diagram of the Scheduling portion of the database model.

FIG. 40 is a data diagram that illustrates the modified Admin portion of the database model, showing how the Admin portion joins to existing database by [rb_Users].[UserID]=[cc_UserBios].[UserID] and [cc_Organizations].[OrgianizationID]=[cc_OrgBios].[OrganizationID]

FIG. 41 is a data diagram that shows how the data joins to existing database by [cc_Events].[EventID]=[cc_PostMeetingQuestions].[EventID] and [cc_Meetings].[MeetingID]=[cc_PostMeetingAnswers].[MeetingID]

FIG. 42 is a data diagram that shows how the data joins to existing database by [cc_Events].[EventID]=[cc_SponsorMeetingQuestions].[EventID] and [cc_OrganizationID].[OrganizationID]=[cc_PostMeetingAnswers].[SponsorID] and [rb_Users].[UserID]=[cc_SponsorMeetingAnswers].[UserID]

FIG. 43 is a data diagram that shows how the data joins to existing database by [cc_EventMeetingRequests].[EventMeetingRequestID]=[cc_ProposedMeetings].[EventMeetingRequestID] And [rb_Users].[UserID]=[cc_ProposedMeetings].[SponsorUserID] And [rb_Users].[UserID]=[cc_ProposedMeetings].[DMUserID].

FIG. 44 is a data diagram that shows how the modified Admin portion of database model joins to the existing database by [cc_UsersToMobileMailbox].[UserID]=[rb_Users].[UserID].

FIG. 45 is a data flow diagram that illustrates processing of the Network Administrator Use Case—Creating Email Addresses

FIG. 46 is a data flow diagram that illustrates processing of the PDA Preparation Use Case.

FIG. 47 is a data flow diagram that illustrates processing of the Attendee Use Cases.

FIG. 48 is a screen shot that shows the Mobile Status Page of the illustrated embodiment.

FIG. 49 is a screen shot that shows the Reminder Screen with Sample Text.

FIG. 50 is a flow diagram that shows the PDA Client Software Flow.

FIG. 51 is a screen shot that shows the Alert Screen with Sample Text.

FIG. 52 is a screen shot, such as will be displayed on the PDA screen of an attendee, that shows a Survey Screen with Sample Survey.

FIG. 53 is a data flow diagram that provides a Communication Sequence Chart showing how the web site, database, and mobile devices interact with each other.

FIG. 54 is a flow diagram that depicts the information flow in a system constructed in accordance with the invention.

FIG. 55 is a depiction of the manner in which the systems provides corporate introduction in accordance with the illustrated embodiments.

### DETAILED DESCRIPTION

1 Introduction

The present invention provides corporate introductions that are based first on creating and maintaining an enhanced business directory database that contains specific parameters that are required for refined matching of business relationships, such as identification of business units of each company in the directory, the products/services provided by each business unit, and the attributes of the ideal customer for each for those products/services, as well as contact information for the executive(s) that head each business unit. A “Connection Meeting” is arranged for a specific group of targeted senior executives as well as other senior executives whom the targeted senior executives may wish to engage for business. Relevant data is obtained from targeted senior executives including some of their key challenges, decisions, and identification of their future business initiatives, particularly those that have not already been committed to a vendor. From the information obtained from the targeted senior executives, a group of their peers whom are also attending the Connection Meeting are arranged to facilitate sharing of experiences that assist and help to identify successful solutions to key challenges and decisions, and a group of sponsors is identified that provide product/service solutions to their uncommitted future business initiatives and introductions are made either in person or on-line. The likelihood of meaningful introductions is dramatically increased when compared with the normal course of business, because needs by the targeted senior executives are identified first and then are matched with applicable peers, and vendor companies in the marketplace who also are represented by their senior executives and private meetings are arranged accordingly. In addition to meeting with the targeted senior executives, the vendor senior executives meet with each other in structured sessions facilitated by a system component that collects information in advance and uses that information to connect them with other vendor senior executives whose company, clients, partners, or associates may have need for their products/services as well.

To arrange and manage all meetings, a system component includes dynamic relational databases; interfaces with third party sales force automation software, a scheduling component and algorithm that creates optimum individual attendee schedules for different types of meetings based on several parameters; and multiple methods of obtaining and displaying upfront information, receiving approval of tentative agendas and displaying schedules, which include on-line, e-mail, instant messaging, personal digital assistant (PDA) applications, and hard copy. A system component obtains immediate feedback following each meeting through a prompted touch screen survey on a mobile device, such as a PDA. The PDA application contributes further to management of meeting activities by displaying schedules, connecting to contact information, biographies and digital images of the parties involved and their companies, and specifics of the uncommitted needs of the targeted executives. Strict privacy and securities methods are utilized so only relevant parties have access to personal data. The PDA application further allows real-time communication between attending parties such that changes in schedules and new meetings can be arranged between attending parties with or without the assistance of an administrator via the PDAs and/or other computer like devices.

The embodiments described herein relate to a new Web-based application that assists in corporate matchmaking, facilitate event registration and scheduling, and to gather and disseminate business intelligence data.

1.1 Market Opportunity

The market opportunity for corporate introductions services is substantial as evidenced by the tens of billions of dollars spent today in business-to-business marketing so companies can introduce their products to senior decision makers, as well as the necessary introductions that precede the hundreds of billions spent in mergers and acquisitions each year, all which involve introducing the top executives of each company. In the discussions below, references to “Corporate Connections” refers to the assignee of the present invention, Corporate Connections, Inc. The implementation of the invention, as described in connection with the various embodiments, will be performed by Corporate Connections, Inc., the assignee.

1.2 Configuration and Methodology

Corporate Connections is a member based service organization that connects C-suite (CEO, COO, CFO, Board of Directors, etc.) and other top executives of Fortune 1000 and $100M+ companies for professional growth, business development, and sharing of business intelligence. Services are facilitated on-line, at member offices, or through regional and national “Connection Meetings”, each focused on a specific group of members, e.g. chief financial officers.

As the single top executive in their respective position, C-suite and other business unit leaders lack a peer group or support network within their company. There is no one else for them to turn to inside their organization that has experience in their position. The demand on their time prevents them from anything other than a chance encounter with another peer at an industry conference or event, which they rarely attend. Corporate Connection fills this void by organizing exclusive forums for specific C-suite executives to learn from and share with their peers, dramatically improving their professional results and creating a peer network for each.

The process of facilitating these invaluable C-suite forums requires the executives to provide unique information. One of the information components for example is identifying their future yet uncommitted business initiatives that require product or service solutions. Utilizing proprietary technology and databases, meetings are arranged with senior executives of applicable market leading vendor companies, who also become members and provide similar data. These arranged meetings reduce sales costs by as much as 75% and eliminates 90%+ of the time otherwise expended by the selected company to reach C-suite executives who are or might be potential buyers of their products/services. Other meetings are arranged between the senior executives of vendor companies to identify and explore additional business development opportunities.

Corporate Connections provides a dramatically more cost effective and efficient method for companies to meet with the top decision makers of large and mid-market companies, who have not only revealed their uncommitted business initiatives, but have agreed in advance to meeting with senior executives of applicable solution providers who provide beneficial products/services for the uncommitted business initiatives. These services dramatically exceed the results of any trade show or conference at a far lower cost.

The information Corporate Connections acquires to facilitate these arranged meetings will in time become a dynamic profile of large and mid-market company's uncommitted business initiatives for the next 6-18 months, that will be more accurate than predictions in most (if not all) market research reports, and represent the budgets of the top executives of corporate America who drive the majority of their company's purchases/investments.

The process of identifying uncommitted business initiatives requires categorizing typical budget items uniquely for each C-suite positions (and in their vernacular), as well as researching and associating market leading companies with each relevant item. The resulting product will evolve into a powerful, on-line, customized business search tool specifically for each C-suite executive position that exceeds the accuracy and validity of a similar search on Google or Yahoo. It also presents a phenomenal opportunity for individual companies to market their products/services at the precise moment each C-suite executive is either looking for information, or selecting a company to'meet with at a Connection Meeting.

1.2.1 Connection Meetings

The “Connection Meetings” are Regional or National gatherings, each featuring and programmed for a particular targeted senior executive position. The Regional meetings will typically last one to one-and-on-half days, while the National meetings will typically last somewhat longer, such as two to two-and-one-half days. The targeted senior executives and senior management of vendor companies requested by the targeted senior executives attend the Connection Meetings.

Each Connection Meeting includes among its activities:

a. Experience Exchange sessions—private and confidential discussions among peer targeted senior executives from different companies sharing wisdom and experience to assist each other with their individual challenges, decisions, and upcoming business initiatives.

b. Executive Business Exchange—private discussions among peer senior executives from different vendor companies to connect them with other vendor senior executives whose company, clients, partners, or associates may have need for their products/services

c. Business Issue Forums—pre-arranged private meetings between targeted senior executives and senior executives of vendor companies they request

1.2.2 Data Examples

As senior executives participate in Connection Meetings, the registration process and several of the meeting formats allow the capture of valuable data that is used to identify applicable “connections” and is archived in a relational database for future retrieval through interactive searches, as well as providing building blocks for developing future revenue streams and enhancing membership value. Some of the data currently being accumulated includes:
Detailed contact information for executives and their assistants
Personal profile information, direct reports, budget authority, etc.
Reporting structure and organization hierarchy of their company
Future business initiatives and which are uncommitted to a particular vendor
All company business units, their product/service offerings, targeted audiences, and who heads up each unit.
Key issues that are impacting most C-suite executives in their position
Best practices and lessons learned categorized by issue (e.g. strategic planning)
Comparative industry/local rates and fees for various items (e.g. internal audit fees)
Speaker presentations, summary reports, white papers, etc.
   1.2.3 Technology

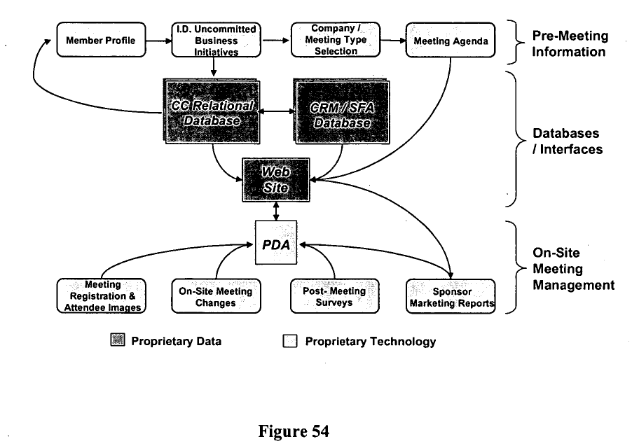

The most valuable assets Corporate Connections is developing as its business evolves are the relationships with top executives of corporate America, and most importantly the data acquired through various forms of interaction and facilitating services with these executives. FIG. 54 illustrates how the developed technology of the illustrated embodiments captures each executive's profile information, identifies uncommitted business initiatives and establishes meetings, as well as manages all activities during the Connection Meeting and acquires survey data after each activity.

The proprietary application platform of the illustrated embodiments was developed for Web-based technology utilizing the “Microsoft .NET” architecture, written in the C# programming language with a digital certificate, such as available from Verisign, for security encryption identical to that used by financial institutions for on-line transactions. The application runs on a database, such as provided by “Microsoft SQL Server 2003”, with a relational database schema. A “Vishnu” scheduling algorithm, originally developed by the Defense Advanced Research Projects Agency (DARPA) of the U.S. government is utilized for maximum efficiency in meeting schedules.

1.2.4 Databases and Interfaces

Corporate Connections Relational Database—Contains information gathered from in-house research, registration profiles and surveys including senior executive contact information, Experience Exchange and Executive Business Exchange data, individual company business units, product and service offerings and target audiences, uncommitted business initiatives, and companies that provide applicable product and service solutions to top executive budget items.

SFA/CRM Database—The sales force automation (SFA) and customer relationship management (CRM) software contains all contact and organizational information for all members including a detailed history of all communications. An interface between the SFA/CRM software and the Corporate Connections database was developed enabling synchronization of data between both sources.

Corporate Web Site—In addition to basic Company information, the web site is the primary interface for event registration, collecting survey information, educational archives, testimonials, and accessing all other information in the Corporate Connections relational database.

1.2.5 Meeting Management

Regardless of advance preparations and agendas, when you get 50+− senior executives together to conduct 100+− meetings over 2 days with people they have never met before, things will happen prior to and during the event requiring real time changes to schedules.

1.2.5.1 Meeting Challenges

All business meetings and even golf outings arranged in advance with specific parties to be present at a particular time, inevitably face three challenges:

1. One or more parties have something come up prior to the date and needs to cancel or reschedule

2. One or more parties have a last minute emergency and need to reschedule

3. One or more parties are late to the meeting

As these circumstances happen in the course of normal business, so too do they happen in facilitating and coordinating Connection Meetings. The reality of facilitating these types of Connection Meetings is that changes in schedules, personnel and other unique requests occur continually prior to and throughout the event, requiring resolution in real time while also disseminating the updated information immediately.

With real time communications all aspects of Connection Meetings management can be made more efficient, dramatically increasing the participants' positive experience and results while at the same time are decreasing Corporate Connections staffing requirements and costs.

1.2.5.2 Connection Meeting Management Technology

In order to disseminate information and update schedules in real time, while also providing the means of visually identifying meeting participants, Corporate Connections utilizes the capabilities of handheld PDA's, Wi-Fi communications, and digital imaging. This technology allows changes in meeting schedules to be efficiently accommodated throughout a Connection Meeting, in order to prevent chaos and disturbed targeted senior executives who are on the receiving end of a changed meeting.

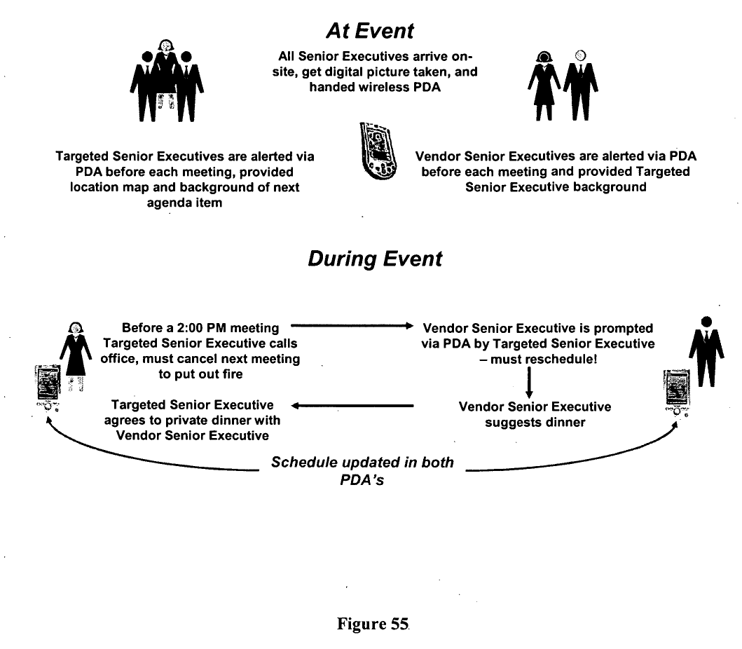

FIG. 55 illustrates typical scenarios in a Connection Meeting environment, and shows how they are accommodated by the Corporate Connections PDA application. It can be seen that PDA communications are utilized both at the time of the event, upon arrival of attendees, and also during the event itself, as schedules are updated in real time.

1.2.6 Wireless PDA Application

This is a proprietary application developed specifically for on-site meeting management and data collection at a Connection Meeting. The current version was developed to operate on an HP Pocket PC device. Interfaces for Palm/Handspring and RIM Blackberry devices will be developed in Q1 of 2006.
Schedules are downloaded into handheld wireless PDAs and managed from a central server (laptop) on-site.
When each activity period is over during a Connection Meeting and the next one needs to begin, each user is prompted/reminded by messages and chimes.
Each activity is followed by a human voice asking the user to click through a brief (20-30 second) survey.
Surveys can be published in real time for the benefit of the vendor sponsors (see “Post Meeting Surveys”).
Should meetings or any changes need to be made on-site, the developed technology can update schedules of impacted parties in real time and send out alerts notifying applicable parties accordingly.
   1.2.7 Utilizing Technology to Expand Connections

It is obvious that the amount of information gathered from members will grow exponentially as Corporate Connections grows from 200 member companies in September 2005, to an estimated 1,000 companies by 2006 year end with 3,000-5,000 or more executives. Consequently the opportunity to make connections between executives will also be growing exponentially.

The advent of social networking technology and products such as that by Visual Path and others based on six-degree separation approaches, are proving successful over the last 3 years bringing together communities of participants and particularly being able to show where there are connections in relationships. This technology is being harnessed and the data will be mined to enhance capabilities in executive connections, while making relationships more efficient to identify and manage through technology. It also provides a significant tool that benefits corporate development activities.

1.3 Scope

The description that follows is organized into the following sections:

Section 2 describes the overall system architecture.

Section 3 describes the security and user roles/permissions used in the system.

Section 4 describes the website design, page layout and navigation.

Section 5 describes the data-model of the system.

2 System Architecture

2.1 Overview

The Corporate Connections web application is based on the web portal application paradigm. A portal application provides each user with a unique and customizable view of data presented in the web browser based on selections and categories chosen by the user. The web portal is made up of a number of components that work together to provide the user with a seamlessly integrated and graphically consistent web experience. Both portal application and data model are designed to allow for future expansion of system features.

2.2 System Design

The system is designed as a set of logical tiers with each tier being made up of several components. Some components overlap tier boundaries to connect tiers together.

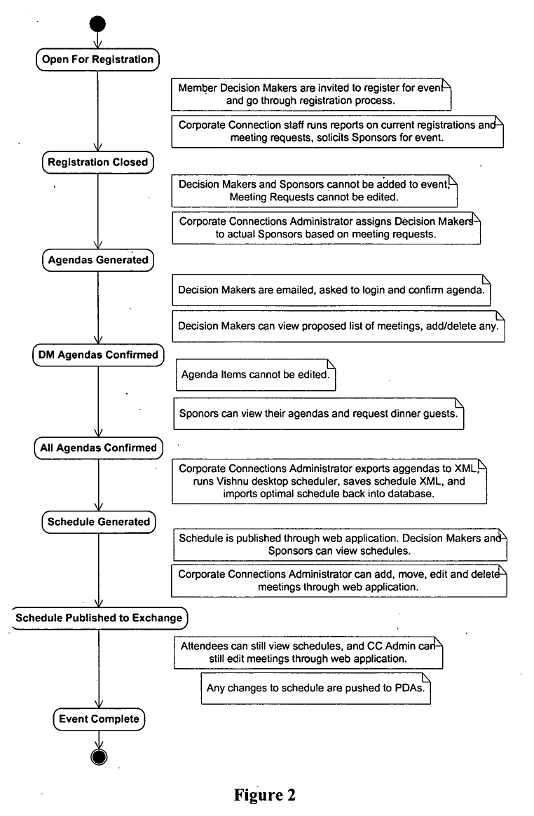

FIG. 2 shows the general system design in accordance with the illustrated embodiments. The largest component in the system is the portal framework and its subcomponents. The framework controls the layout, organization and user access security of the site, while the portal components provide the user interaction, business logic and data access. Each portal component is self-contained so that new ones can be installed with a minimal amount of configuration. So in this design the overall presentation is controlled by the framework layout and style-sheets and individual data presentation is handled by the specific portal component.

Each component handles the business logic and data access for itself. If a component requires complex business logic, additional business tier components will be added. A Salesforce.com module and Optimizing scheduler module have also been generated improve the content management integration and our ability to find the best schedule matches.

The data tier is comprised of a SQL Server database and any flat files that are accessible to users through the portal. The Application server takes the SQL data and communicate it to the PDAs.

2.3 System Components

2.3.1 Portal Software

In the illustrated embodiment, the “Rainbow” open source portal framework was utilized. Other portal frameworks can be utilized. The Rainbow portal is convenient because is written so that portal customization and extension is possible. A custom layout and style-sheet can be implemented to customize the look and feel of the portal and extra components can be written and plugged into the framework to extend the portal's functionality.

The portal framework uses a combination of configuration data stored in the database and the users assigned rights to determine what portal components or modules are loaded on the page and how the user can interact with the module. A portal module is a discreet set of data and functionality that fits on a tab or page in the portal. Each portal page can have multiple modules displayed at one time, in either left, center or right panels.

A single user role can have the following rights to a module:
view: the user can view the data, if a user does not have this permission the module is not visible to the user.
edit: the user can edit a piece of data in the module.
add: the user can add another piece of data to the module.
modify properties: the user can modify the modules properties i.e. how it displays its self or its data.

In the illustrated embodiment, a variety of modules are utilized. Others may be developed to fit the data-model needs of the Corporate Connections Portal.

Existing Portal Components

HTML

Sign In

Links

Article

Announcement

Image

Shortcut

Menu

Send thoughts

Portals used in this project will be based on the existing portals where possible.

2.3.2 Scheduling Software

2.3.2.1 Overview

A key feature of the Corporate Connections application is the ability to schedule meetings between sponsors and decision makers at events. These meetings are based on requests made by the decision makers in the event registration process.

FIG. 2 is a flow diagram that provides an overview of the event registration and scheduling workflow, including the event statuses at each stage.

2.3.2.2 Vishnu Scheduler

The meeting requests, event sponsors and general event information is exported to an XML format that is recognized by the scheduling application (see below for a description of the Vishnu scheduling application and the XML file format).

The Vishnu scheduling application uses a genetic algorithm to determine an optimal schedule of meetings to meet as many of the meeting requests as possible. The optimized schedule is then be exported from the Vishnu scheduler, and read back into the Corporate Connections application through an administration tool.

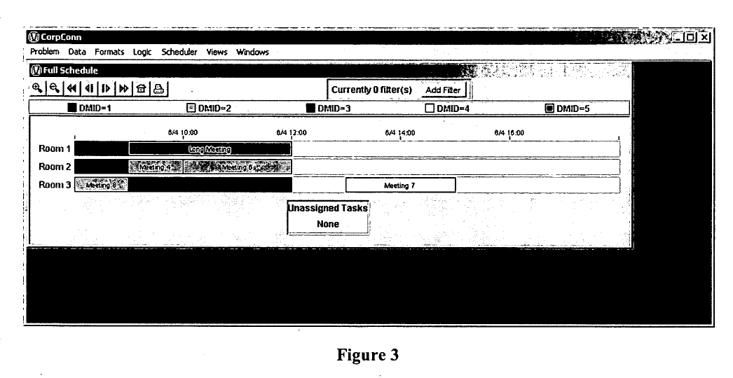

FIG. 3 is a block diagram that illustrates the Vishnu Desktop Scheduler

The initial scheduling of events is handled by an application called Vishnu (http://vishnu.bbn.com). Vishnu is a Java system that can be run as a desktop application that reads and writes XML files, but can also be configured to run as a web application (using Apache, PHP and MySQL). For future releases, this functionality could be integrated into the web application as an admin tool if necessary.

There are two separate Vishnu data models (.VSH formats) developed for Phase III. One is the meeting scheduler, and the other arranges dinner seating arrangements.

2.3.2.3 Meeting Scheduler

The meeting scheduler is responsible for generating an optimal schedule of meetings between sponsors and decision makers. This scheduling algorithm is based on sponsor rooms, decision makers, meeting requests and event meeting time slots. The algorithm will not allow rooms or attendees to be double-booked.

2.3.2.4 Dinner Seating Arranger

The dinner seating arranger is responsible for matching sponsor dinner tables with decision makers. This algorithm is based on meeting requests, dinner invitation requests, sponsor tables, decision makers and event meal time slots. The algorithm attempts to not assign decision makers to sponsors who they are already meeting with through the meeting requests. It also tries to balance the first, second, and third choices that sponsors have selected in their dinner invitation preferences (i.e. try to balance the number of first choices amongst all sponsors).

2.3.2.5 Vishnu XML File Format

Following is a sample (empty) Vishnu scheduling problem XML file:

```
  <?xml version=“1.0”?>
  <PROBLEM name=“new” description=“”>
  <DATAFORMAT/>
  <SPECS direction=“minimize” multitasking=“none”>
    <COLORTESTS/>
    <FILTERS/>
    <VIEWS/>
  </SPECS>
  <GAPARMS pop_size=“100” parent_scalar=“0.9” max_evals=“500”
max_time=“600” max_duplicates=“10000”
max_top_dog_age=“10000” report_interval=“15”
initializer=“com.bbn.vishnu.scheduling.SchInitializer”
initializer_parms=“0”
evaluator=“com.bbn.vishnu.scheduling.SchEvaluator”>
  </GAPARMS>
  <DATA />
  <ASSIGNMENTS/>
  <COMMITMENTS/>
  </PROBLEM>
```

This is the file format that will be imported and exported from/to the Corporate Connections database using the Schedule Import/Export administrative tool. Vishnu stores these files with a .VSH extension.

The elements of the Vishnu XML format are listed and described below, along with examples of the formats that are used for the meeting scheduler model. There is a 2^{nd} scheduler model developed specifically for dinner meetings.

2.3.2.5.1 Dataformat

This section of the XML document describes the data format for the objects that make up the scheduling problem. For Corporate Connections, this will be made up of Meetings (tasks) and Rooms (resources). The meeting elements include one or more sponsor UserID's and a Decision Maker's UserID. The XML definition for the meeting scheduler are similar to:

```
  <DATAFORMAT>
    <OBJECTFORMAT name=“Meeting” is_task=“true”
    is_resource=“false”>
    <FIELDFORMAT name=“MeetingID” datatype=“string”
is_subobject=“false” is_list=“false” is_key=“true”
      is_globalptr=“false”/>
    <FIELDFORMAT name=“SponsorID” datatype=“string”
is_subobject=“false” is_list=“false” is_key=“false”
      is_globalptr=“false”/>
    <FIELDFORMAT name=“DMID” datatype=“string”
is_subobject=“false” is_list=“false” is_key=“false”
      is_globalptr=“false”/>
    <FIELDFORMAT name=“Hours” datatype=“number”
is_subobject=“false” is_list=“false” is_key=“false”
      is_globalptr=“false”/>
    </OBJECTFORMAT>
    <OBJECTFORMAT name=“Room” is_task=“false”
    is_resource=“true”>
    <FIELDFORMAT name=“RoomID” datatype=“string”
is_subobject=“false” is_list=“false” is_key=“true”
      is_globalptr=“false”/>
    <FIELDFORMAT name=“Name” datatype=“string”
is_subobject=“false” is_list=“false” is_key=“false”
      is_globalptr=“false”/>
    </OBJECTFORMAT>
  </DATAFORMAT>
```

2.3.2.5.2 SPECS

This section of the XML document defines the scheduling logic that is implemented to solve the scheduling problem. This includes code to calculate the capability of a resource (Room) to perform a task (host a Meeting), as well as code to optimize the schedule. The specs for the Corporate Connections scheduling problem will need to be developed and optimized with real data once it is available.

2.3.2.5.3 GAPARAMS

This section of the document contains the genetic algorithm parameters to be utilized when optimizing the schedule. This includes the sample population size and mutation probability. The parameters for the Corporate Connections scheduling problem will need to be developed and optimized with real data once it is available.

2.3.2.5.4 DATA

This section of the document holds the actual scheduling data to be passed in to the scheduling algorithm. In the case of Corporate Connections, this includes meetings and rooms. The format of these elements are similar to:

```
<OBJECT type=“Meeting”>
  <FIELD name=“MeetingID” value=“Meeting 1”/>
  <FIELD name=“SponsorID” value=“2”/>
  <FIELD name=“DMID” value=“2”/>
  <FIELD name=“Hours” value=“1”/>
</OBJECT>
<OBJECT type=“Meeting”>
  <FIELD name=“MeetingID” value=“Meeting 2”/>
  <FIELD name=“SponsorID” value=“4”/>
  <FIELD name=“DMID” value=“1”/>
  <FIELD name=“Hours” value=“1”/>
</OBJECT>
<OBJECT type=“Room”>
  <FIELD name=“RoomID” value=“1”/>
  <FIELD name=“Name” value=“Room 1”/>
</OBJECT>
```

There are also be objects defined to represent round-table discussions and round-table exclusions (where a user has asked not to be at the same discussion as another user).

2.3.2.5.5 ASSIGNMENTS

This section of the XML document holds the optimal scheduling assignments after the Vishnu scheduling algorithm has been run (scheduled Meetings). This is the data that is imported back into the Corporate Connections site as the initial published schedule. The data format is similar to:

```
    <ASSIGNMENTS>
      <ASSIGNMENT task=“Meeting 1” resource=“3”
setup=“2004-06-04 11:00:00” start=“2004-06-04 11:00:00”
      end=“2004-06-04 12:00:00” wrapup=“2004-06-04 12:00:00”
color=“blue” text=“Meeting 1” frozen=“no”/>
      <ASSIGNMENT task=“Meeting 2” resource=“2”
setup=“2004-06-04 08:00:00” start=“2004-06-04 08:00:00”
      end=“2004-06-04 09:00:00” wrapup=“2004-06-04 09:00:00”
color=“darkred” text=“Meeting 2” frozen=“no”/>
    </ASSIGNMENTS>
```

2.3.2.6 Vishnu Scheduling Logic

Vishnu is completely configurable, in that it allows code to be entered to specify how a particular scheduling problem should be solved. This code is in a Vishnu-specific language. Corporate Connections requires two separate Vishnu schedulers, one for scheduling meetings and another for assigning dinner seating arrangements. For the Corporate Connections meeting scheduler model, the code is similar to: The scheduler is able to take the raw data, the number of attendees, their requested meetings, and combine with the number of time slots and types available to optimize the schedule.

Optimization Criterion (calculation of how good a specific schedule is):

Iterate over tasks. Sum up cases where two tasks are scheduled at the same time with the same meeting attendees (should be impossible with capability criterion listed below).

```
sumover (tasks,
  “t1”,
  sumover (tasks,
    “t2”,
    if (hasvalue (resourcefor (t1)),
      if (hasvalue (resourcefor (t2)),
      if (taskstarttime (t1) = taskstarttime (t2),
        if (or (t1.SponsorID = t2.SponsorID, t1.DMID = t2.DMID),
        1.0E9,
        0.0),
      0.0),
      1.0E9),
    1.0E9)))
```

Delta Criterion (added cost of assigning a particular meeting to a particular room):

The new end time for the Room (when all meetings are complete for that room for the event) minus the Event start time.
9999999.0*(complete(resource)−start time)

Capability (boolean, whether or not a particular room can host a particular meeting):

For each task already scheduled, check to see if it is scheduled to start at the same time. If it is, check to see if any of the meeting attendees are the same. If so, return false.

```
if (orover (tasks,
    “t”,
    if (taskstarttime (t) = taskstarttime (task),
      if (or (t.SponsorID = task.SponsorID, t.DMID = task.DMID),
      false,
      true),
      true)),
  false,
  true)
```

Task Unavailable (list of time intervals when meetings cannot be scheduled):

For example, for an event that starts at 8:00 AM, to define a break from 12:00 to 1:00 PM:

list (interval (start_time + 3600.0 * 4.0,
start_time + 3600.0 * 5.0))

2.3.3 Saleforce.com Integration Software
2.3.3.1 Overview

Another key component of the Corporate Connections application is the ability to transfer and reconcile data between the Corporate Connections database and Salesforce.com. Salesforce.com is an online CRM (customer relationship management) and sales force tool. Corporate Connections staff uses Saleforce.com to manage and store Accounts, Contacts and Sales leads. Salesforce.com is considered the primary data store for holding information about organizations and contacts and this data is transferred into the Corporate Connections Database to create new users and organizations, and pre-populate the data.

Once users have been created and they access the Corporate Connections Portal they have the opportunity to change their personal information. These changes then have to be reconciled back into Salesforce.com through a manual process by the Corporate Connections Administrator. The manual process is a requirement because the reconciliation process involves a high degree of personal judgment, and this also protects the integrity of the salesforce.com data.

Before data can be reconciled between the two systems it must first be mapped, so that the system knows which records and fields it must compare between the two systems. In general there are two datasets that exist in both systems and must be reconciled:
1. Salesforce.com Contacts to CorpConn Users
2. Salesforce.com Accounts to CorpConn Organizations

If a record does not exist in the Corporate Connections database the Portal Administrator has the option of creating a new record and copying the data from Salesforce.com. If a record exists in Corporate Connections and not is Salesforce.com (not standard procedure) then the Salesforce.com Admin must first create a new record in Salesforce.com and update the local copy of the salesforce data before the mapping process can begin.

2.3.3.2 Salesforce.com

Salesforce.com is a web based CRM application. It is programmatically accessible via web services and SOAP calls. This allows users to programmatically login, query data, create, update and delete records from Salesforce.com. Below is an example of C# code used to access the Salesforce.com Web Service. Data is returned in XML and placed into objects that can then be accessed programmatically.

```
  private bool login( )
    {
      //Get the user name and password from the console
      Console.Write(“Username: ”);
      string username = Console.ReadLine( );
      Console.Write(“Password: ”);
      string password = Console.ReadLine( );
      //create a new instance of the web service proxy class
      binding = new sforce.SforceService( );
      try
      {
      //execute the login placing the results
      //in a LoginResult object
      sforce.LoginResult loginResult = binding.login(username,
password);
      //set the session id header for subsequent calls
      binding.SessionHeaderValue = new sforce.SessionHeader( );
      binding.SessionHeaderValue.sessionId = loginResult.sessionId;
      //reset the endpoint url to that returned from login
      binding.Url = loginResult.serverUrl;
      return true;
    }
    catch (Exception ex)
    {
      //Login failed, report message then return false
      Console.WriteLine(“Login failed with message: ” + ex.Message);
      return false;
    }
  }
  private void querySample( )
    {
      //The results will be placed in qr
      sforce.QueryResult qr = null;
      //We are going to limit our return batch size to 3 items
      binding.QueryOptionsValue = new sforce.QueryOptions( );
      binding.QueryOptionsValue.batchSize = 3;
      binding.QueryOptionsValue.batchSizeSpecified = true;
      try
      {
      qr = binding.query(“select FirstName, LastName from Contact”);
      bool done = false;
      if (qr.size > 0)
      {
        Console.WriteLine(“Logged in user can see “ + qr.records.Length
+ ” contact records.”);
        while (!done)
        {
        Console.WriteLine(“”);
        for (int i=0;i<qr.records.Length;i++)
        {
        sforce.Contact con = (sforce.Contact)qr.records[i];
        string fName = con.FirstName;
        string lName = con.LastName;
        if (fName == null)
        Console.WriteLine(“Contact ” + (i + 1) + “: ” + lName);
        else
        Console.WriteLine(“Contact ” + (i + 1) + “: ” +
        fName + “ ” + lName);
        }
      if (qr.done)
      {
        done = true;
      }
      else
      {
        qr = binding.queryMore(qr.queryLocator);
      }
      }
      }
      else
      {
      Console.WriteLine(“No records found.”);
      }
    }
    catch (Exception ex)
    {
      Console.WriteLine(“\nFailed to execute query successfully, error
message was: \n” + ex.Message);
    }
      Console.WriteLine(“\n\nHit enter to exit...”);
      Console.ReadLine( );
    }
  }
}
```

It is also possible to query salesforce to return a list of objects that have been updated between a set of dates. This allows programmers to create a local copy of the salesforce data and keep it up to date with a minimal amount of data transfer, but requires that this date information be stored in the database as part of the configuration data.

2.3.3.3 Data Mapping

A local copy of the Salesforce.com Data is kept in the CorpConn Portal Database. This allows easier access to the data and faster query times. Before mapping can begin the local dataset is updated from Salesforce.com; this occurs when the Administrator clicks the update button. Then the CorpConn Admin can manually map records between the Salesforce.com data and the CorpConn data.

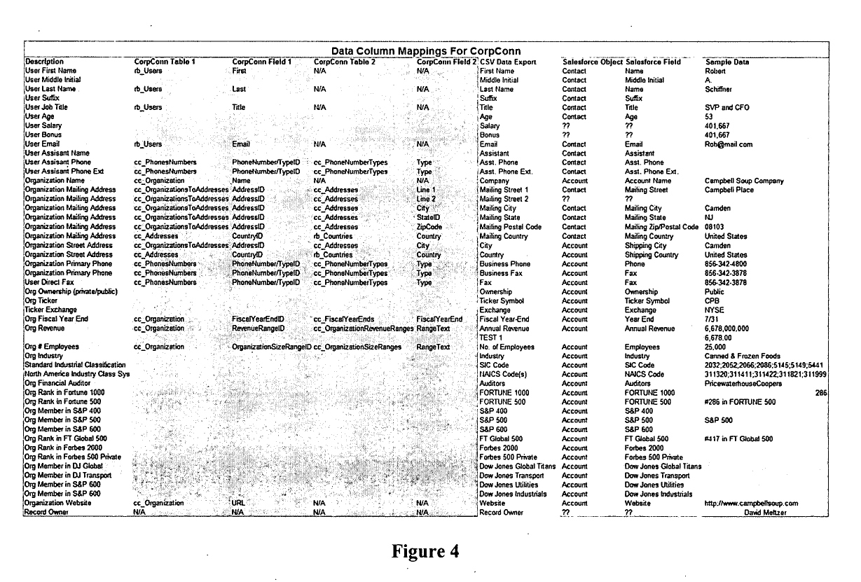

FIG. 4 shows a data table maintained by the system, showing how data fields are mapped from Salesforce.com to Corporate Connections.

2.3.3.4 Data Reconciliation

A summary report is produced for both Users and Organization that shows which records have discrepancies. The CorpConn Admin can then click on the record to view a form in which both the CorpConn data and mapped Salesforce.com Data is visible. Then the Admin will be able to copy the data between both sides in a bidirectional manner. The Admin then clicks update and both sets of data are updated. The Salesforce.com data is updated directly to Salesforce.com and then retrieved back to the CorpConn database. Data reconciliation only occurs on mapped records. If a record is deleted from salesforce.com or Corporate Connections then the mapping is broken and the record will be listed as unmapped.

2.4 System Deployment

The system deployment comprises a web server hosting the application code and flat files, and a database server containing the portal database.

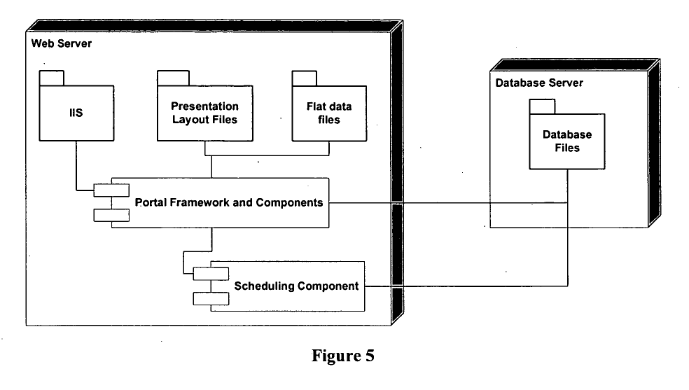

FIG. 5 is a System Deployment diagram that shows the relation between the web components and the sql database.

3 Security/User Access and Roles

3.1 Overview

The portal has multiple levels of security, which will include a username and password to gain access to the site and could include SSL encryption of data while the user is logged into the site. Users have multiple levels of access to the portal. These levels of access can be defined and assigned by system administrators and limit the data and portal components that are accessible to the user.

3.2 Use Cases

Use cases show how a particular user interacts with or “use” the system. While this helps determine system functionality requirements, it also shows how user roles and permissions should be configured based on access to system functionality.

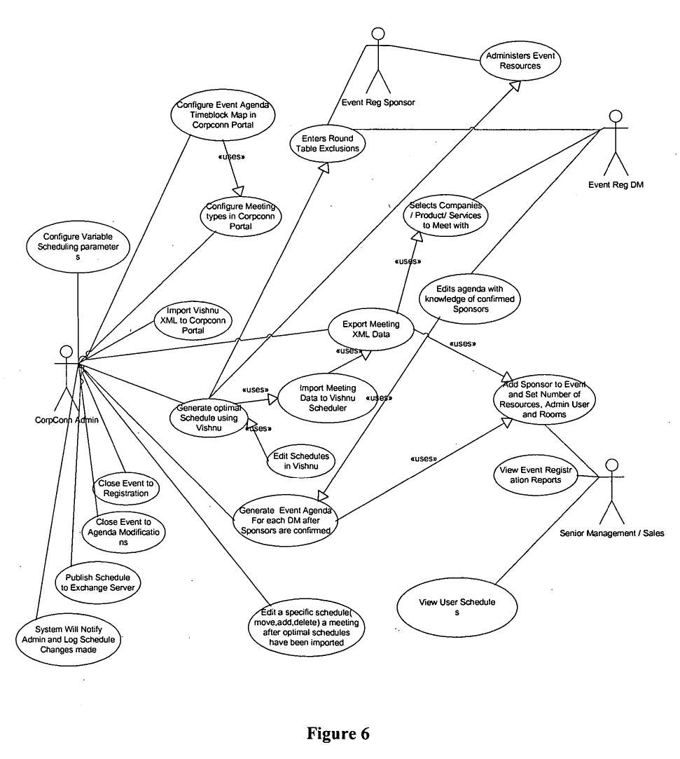

FIG. 6 shows a Scheduling scenario with how an administrator would interact with the system and the experience a user would have.

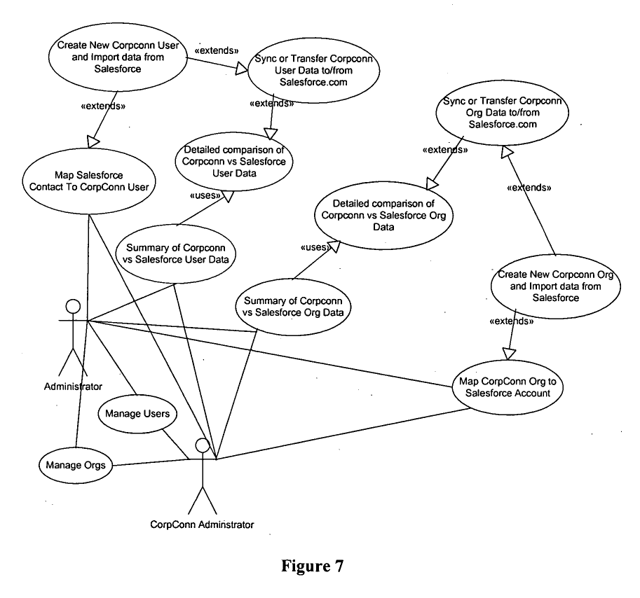

FIG. 7 shows Salesforce.com integration with the system and how information is transferred back and forth between the two.

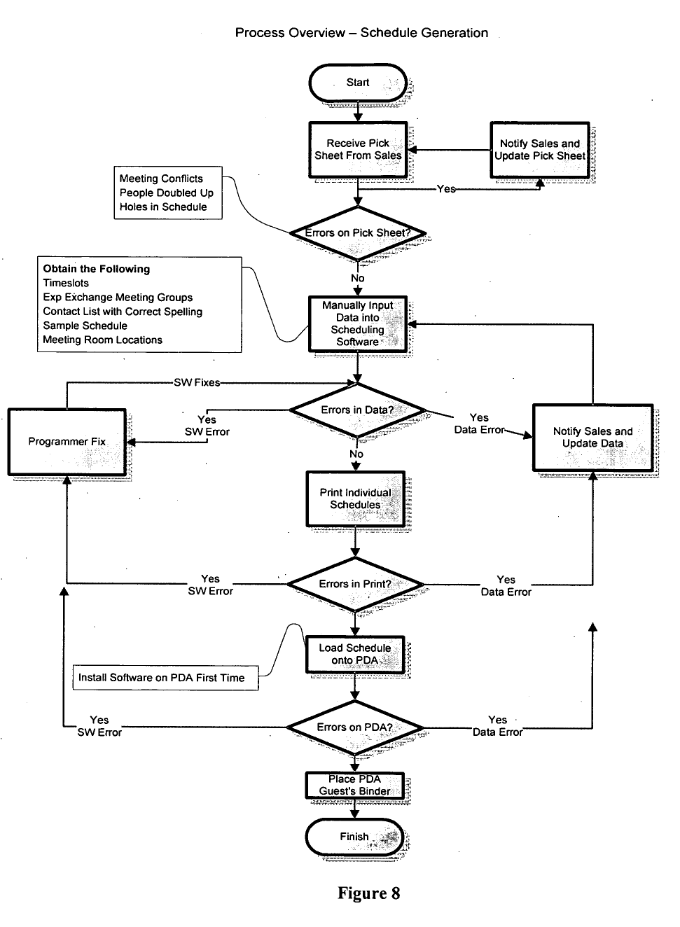

FIG. 8 shows Process Overview Schedule Generation diagram that shows the flow of the system and how an administrator is able to generate a schedule and the checks in place to ensure accuracy.

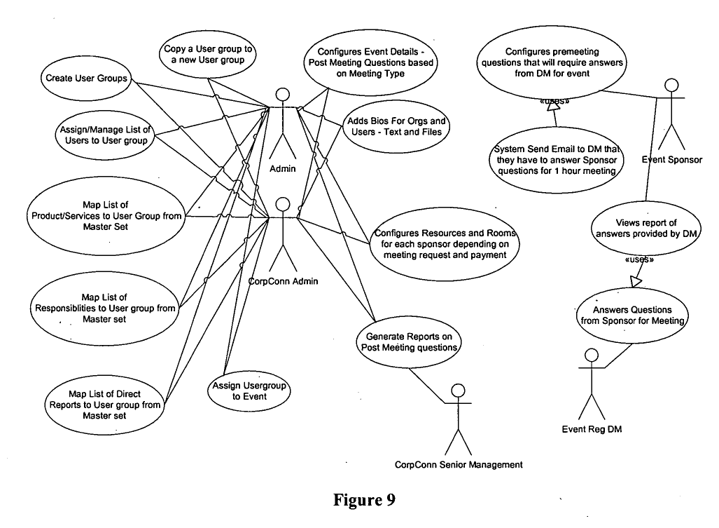

FIG. 9 shows the CorpConn Portal and the different levels of administrators and what their roles are.

User Roles

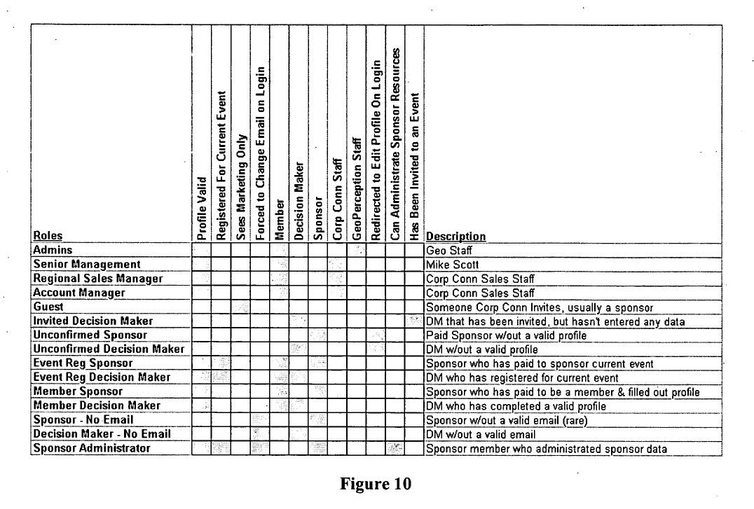

From the Use Case diagram, the major user roles can be determined. These roles can then be applied to the website map to show user access to site pages and components. Below in Table 1 is a list of User Roles, their descriptions, and components they can access in the Corporate Connections Portal application. The Table 1 User Roles information shows the relation to each potential person accessing the system and their ability to see specific areas. FIG. 10 shows a Roles Grid that simplifies the User Roles Table 1 information and explains which user groups access the system and at what level.

TABLE 1

| User Type or | | |
|---|---|---|
| Role | Page/Component Access | Functionality |
| Administrator | All Tabs - All Components | Ability to administer the entire site |
| | | Change all content |
| | | Administrate Users |
| | | Administrate/Assign Roles |
| | | Create/Manage Events |
| | | Create/Edit User Schedules etc. |
| | | Administrate Tabs/Administrate |
| | | Components |
| CorpConn | All Tabs - All Components | Ability to administer the parts of site: |
| Administrator | | Administrate User Data |
| | | View reports |
| | | Administrate events and agenda data |
| | | Assign Users to Events |
| | | Assign Sponsors to Events |
| | | Assign User to Company |
| | | View Event Reports |
| | | Administrate company data |
| | | Change Site Content - HTML |
| | | Cannot Modify Portal properties |
| | | Cannot Modify Component properties |
| Senior | All Tabs - All Components | Ability to administer the parts of site: |
| Management | | View User Data |
| | | View Reports |
| | | View Schedules/Agendas |
| | | View Event Reports |
| | | Cannot Modify Portal properties |
| | | Cannot Modify Component properties |
| Regional Sales | Undefined | Ability to view register user parts of the |
| Manager | | site and processed business intelligence |
| | | data |
| | | No Pages in first phase |
| Account | Undefined | Ability to register user parts of the site |
| Manager | | and processed business intelligence data |
| | | No Pages in first phase |
| Unauthenticated | Home - UnAuthenticated | User not logged in: |
| User | Welcome Component | View only Login Page |
| | Home - Login Component | |
| | Contact Us | |
| Guest | All Pages - Only Marketing | User can login but only see marketing |
| | Content Comps | description of site components not |
| | Contact Us | actual site content. |
| | | View only marketing pages |
| REMOVED as | REMOVED - implemented by | REMOVED - implemented by checking |
| Role | checking user to event table | user to event table |
| Invited | Event Registration Sub Tab - | Used Only to determine if user should |
| Decision Maker | redirected at login | see Event Registration |
| (Used in | This forces the user to be | On log in if user has this they will be |
| conjunction | redirected may choose to fill in | directed to registration page. |
| with other | and complete event | |
| roles) | registration. Become Event | |
| | Register after registration data | |
| | entered. | |
| Unconfirmed | Edit User Profile - redirected | Has limited access to the site, must fill |
| Sponsor | at login | in or confirm user data before accessing |
| | Home - Welcome Component | the rest of the site. Has Paid for access. |
| | All Other Pages - Only | Can Access the Event Registration page |
| | Marketing Content | if registered for event and User Profile |
| | Contact Us | page |
| | When this user completes | Paid in full. |
| | profile they become member | |
| | sponsor | |
| Unconfirmed | Edit User Profile - redirected at | Has limited access to the site, must fill |
| Decision Maker | login | in or confirm user data before accessing |
| | Home - Welcome Component | the rest of the site. |
| | All Other Pages - Only | Can Access the Event Registration page |
| | Marketing Content | if registered for event and User Profile |
| | Contact Us | page |
| | When this user completes | |
| | profile they become member | |
| | Decision Maker | |
| Member | All Tabs - Except Event Sub | Has filled in profile |
| Decision Maker | Tabs | Access to full site |
| | | Not Event Registration |
| | | Not Event Status/Schedule |
| Member | All Tabs - Except Event Sub | Has paid for membership and/or |
| Sponsor | Tabs | sponsored event |
| | | Paid in full |
| | | Access to full site |
| | | Not Event Registration |
| | | Not Event Status/Schedule |
| Event | Events - All General Sub Tabs | Has completed registration for an event, |
| Registered | Events - DM specific Sub Tabs | is member DM but also: |
| Decision Maker | (undefined) | Event Management/Schedule |
| (Used in | | |
| conjunction | | |
| with other | | |
| roles) | | |
| Event | Events - All General Sub Tabs | Has paid to be a sponsor of an event, is |
| Registered | Events - SP specific Sub Tabs | member Sponsor but also: |
| Sponsor | (undefined) | Event Management/Schedule |
| (Used in | | |
| conjunction | | |
| with other | | |
| roles) | | |
| Sponsor - No | Home - Email Change | A Sponsor who has been sent a |
| Email | Component | temporary username/password. Has not |
| | Home - Welcome Component | entered a valid email/password. |
| | Contact Us Tab | No access to site until valid |
| | | email/password entered |
| Decision Maker - | Home - Email Change | A Decision Maker who has been sent a |
| No Email | Component | temporary username/password. Has not |
| | Home - Welcome Component | entered a valid email/password. |
| | Contact Us | No access to site until valid |
| | | email/password entered |

4 Website Layout and Navigation
4.1 Overview

The website layout and navigation is comprised of several areas, the look and feel of each page, the purpose of each page and how the site is navigated. As website functionality grows so does the number pages on the site, it is important to have a site-map so that is possible to view the users movement through the site. The portal software allows for the consistent application of a website layout and style by using panel templates and CSS styles. It also allows the administrator to determine where each page is located on the site and how it is accessed.

4.2 Sitemap

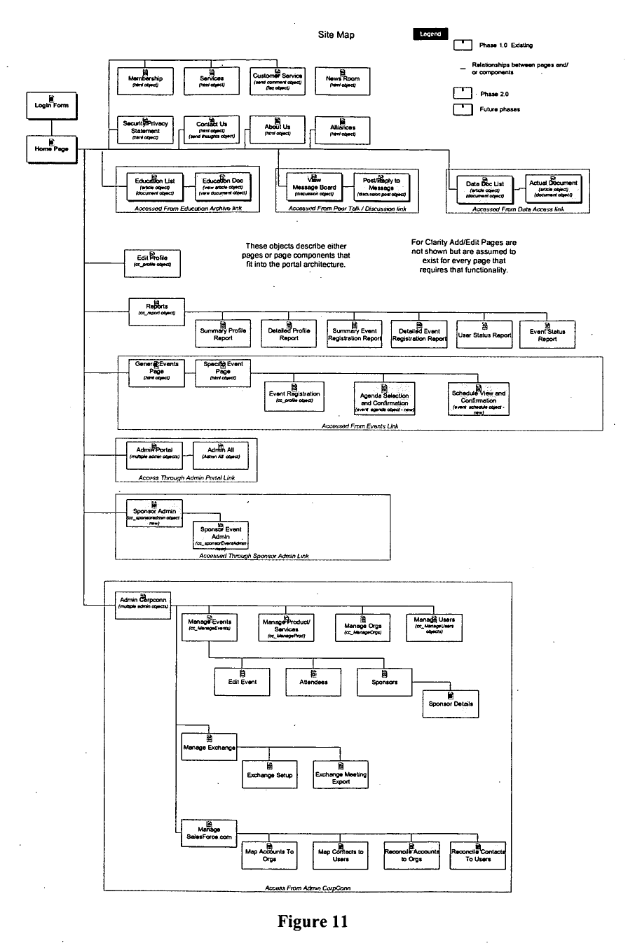

FIG. 11 shows the Corporate Connections Portal Site Map that shows the website layout or map in relation to the home page. It shows how pages are grouped together and how they are navigated.

4.3 Login Workflows

Depending on the user's current status, the login and initial access to the site are slightly different.

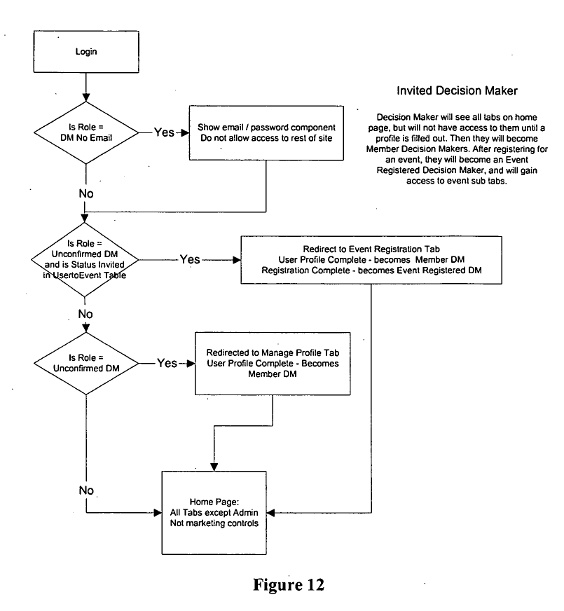

FIG. 12 shows the Invited Decision Maker Logon Workflow that shows how invited decision makers are handled at login.

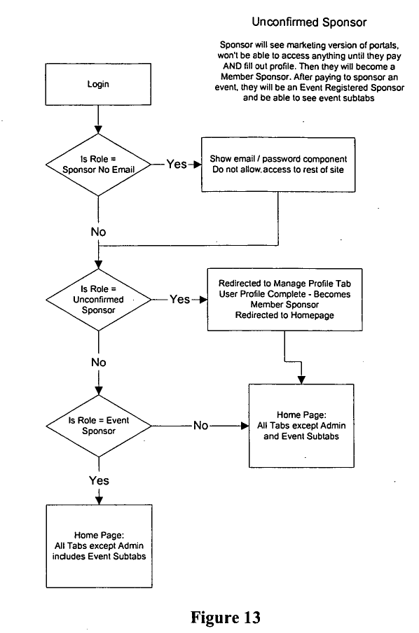

FIG. 13 shows the Unconfirmed Sponsor Logon Workflow that shows how an unconfirmed (non-member) sponsor access the site. Note that they will be viewing marketing versions of portals, encouraging them to become a paid member.

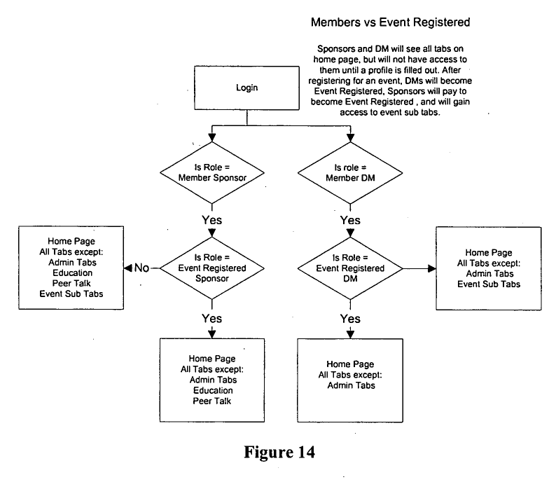

FIG. 14 shows the Member Logon Workflow that shows what a decision maker will see versus a sponsor when logging into the site.

4.4 Portal Page Layout

The diagram below shows some of the configurable options of the portal lay out. Each section can also have CSS styles associated with it.

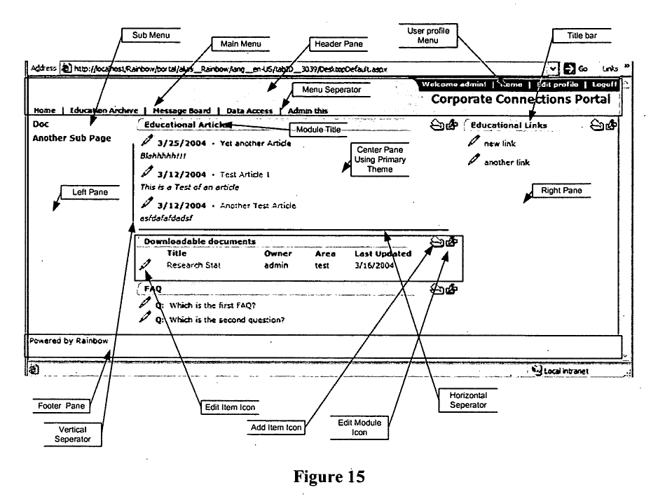

FIG. 15 is a screen shot that provides a Layout Sample showing the basic setup of information and how it will be displayed on the page, regardless of who signs in.

4.5 Portal Objects

4.5.1 About Us

Purpose: This portal component will show static text describing Corporate Connections.

Visible By: All users

Inherits: HTML Object

4.5.2 Membership

Purpose: This portal component shows static text describing the benefits of membership in Corporate Connections, and how to become a member. For existing members, it has info on upgrading and renewing membership.

Visible By: All users

Inherits: HTML Object

4.5.3 Services

Purpose: This portal component shows static text describing the services offered by Corporate Connections.

Visible By: All users

Inherits: HTML Object

4.5.4 Privacy & Security

Purpose: This portal component shows static text describing the privacy and security model used by the Corporate Connections website.

Visible By: All users

Inherits: HTML Object

4.5.5 Contact US

Purpose: This portal component allows users to submit a form that will be mailed to the specified email address.

Visible By: All users

Inherits: HTML Object

4.5.6 Newsroom

Purpose: This portal component will show news articles.

Visible By: All users

Inherits: Announcement Object

4.5.7 Alliances

Purpose: This portal component will show Corporate Connection alliances.

Visible By: All users

Inherits: HTML Object

4.5.8 Education Archive—Marketing Version

Purpose: This portal component displays information on what education data is available to members. It is a marketing version of the Education Archive portal, visible only to non-members.

Visible By: Guests

Inherits: HTML Object

4.5.9 Education Archive

Purpose: This portal component shows documents and presentations relating to previous events.

Visible By: Event-registered users

Inherits: Document Object; Article Object

4.5.10 Customer Service

Purpose: This portal component allows users to contact Corporate Connections for customer service.

Visible By: All users

Inherits: HTML Object

4.5.11 Peer Talk

Purpose: This portal component allows users to communicate through a message board.

Visible By: Members

Inherits: Discussion Object

4.5.12 Data Access—Marketing Version

Purpose: This portal component displays information on what data is available to members. It is a marketing version of the Data Access portal, visible only to non-members.

Visible By: Guests

Inherits: HTML Object

4.5.13 Data Access

Purpose: This portal component allows users to query the database of business info collected on the Corporate Connections site.

Visible By: Members

Inherits: Document Object; Article Object

4.5.14 Profile Manager

Purpose: This portal component allows users (members) to manage their profile.

Visible By: All users

Inherits: None

The profile manager is used to manage information about individual members on the Corporate Connections site. Profiles expire every six months, at which time the member will be forced to review and update their profile before being able to access the portal objects that are viewable to members only. The profile manager will be presented to the user in three stages, which may be controlled through a tab-interface, depending on the final site design. Some of the information will be pre-populated where possible. The three ‘tabs’ are:

Basic Information

Basic user information includes:
Name
Company
Address
Phone numbers of various types
email
Web URL (for company)
Fiscal Year (month)
Revenue—pick from range
Company Size

Position Information

The position info tab/screen gathers information on the user's position within the company, and on other users who report to them. This information is used to build information on corporate structures within companies. Information gathered here includes:
Title (text)
Responsibilities (select from list, user will be able to add items)
Direct Reports (select from list, user will be able to add items)
Budget Authority (selecting from a set of ranges)

Purchasing Priorities

This tab/screen gathers information on the user's purchasing priorities for the next year. The user select from a long list of categories and sub-categories. The list is presented in a collapsible tree format, and only the sub-categories are selectable.

4.5.15 Events—Marketing Version

Purpose: This portal component displays information on upcoming Corporate Connections events. It is a marketing version of the Event Registration Manager, visible only to non-members.

Visible By: Guests

Inherits: HTML Object

4.5.16 Event Registration Manager

Purpose: This portal component allows users to manage their registration to Corporate Connections events.

Visible By: Members

Inherits: Profile Manager

Registered members see a list of upcoming events (usually just one). If they are registered, they will see a link to view/update their registration. If they are not registered, they will see a link to register. While the event is open for registration, the user will see a tree-based view of categories and sub-categories that reflect their selections in the profile manager. Beside each selected category, the user will have the option of selection either
(A) To meet with X of the top companies offering services in the sub-category (X is a number selected from a drop-down list). These are assumed to be 30-minute introductory meetings.
OR:
(B) To meet with specific companies, selected from a multi-select list. The companies in the list represent companies from the database offering services in the sub-category. The user will be able to select as many of the companies as they want. These are assumed to be 60-minute proposal meetings. If a company that they are interested in is not in the list, they will be able to add a company to the list by typing in the name. The new company will be added to the database if it is not already there, and associated with the category. It will not, however, become a default selection until it is flagged as one in the database (i.e. by an administrator).

The system verifies that the user has selected the minimum number of meetings and that the total meeting time is within the minimum/maximum meeting time set for the event. The system will not allow them to continue if the validation fails. An administrator sets the maximum/minimum meeting time for the event in the database, as well as the minimum number of meetings that a Decision Maker must request. It is assumed that all meetings will be scheduled to start on the hour, so half hour meetings cannot be combined into an hour for these calculations. No Maximum number of meetings is required but not all meeting request may be fulfilled.

The user will also be asked to enter, in free text format, the three most important decisions they are expecting to make in the next year. These responses will be used to determine the topics for the experience exchange meetings.

The Event Registration allows the portal object to:
Agenda review
Meeting verification
Sponsor attendee selection for dinner table meetings
Pre-meeting Info exchange—Sponsor company can enter 3 questions for event, show questions to Decision Makers, show answers to Sponsors
Links to schedules
Sponsor resource editing—staff who will attend
Decision Maker selection of other DMs they don't wish to meet in experience exchange meetings.
Sponsor selection of other sponsors to have meetings with during DM experience Exchanges.
   4.5.17 Event Setup Control

Purpose: Allows Corporate Connections Administrators to setup the time slots that will make up an event. This includes meeting times, lunch breaks, round-table discussion times, etc. The user will fill in a table of hourly start times and specify what type of activity is to take place at that scheduled time. This schedule outline will be used later by the scheduling modules to generate individual user schedules.

Visible By: Corporate Connections Administrators

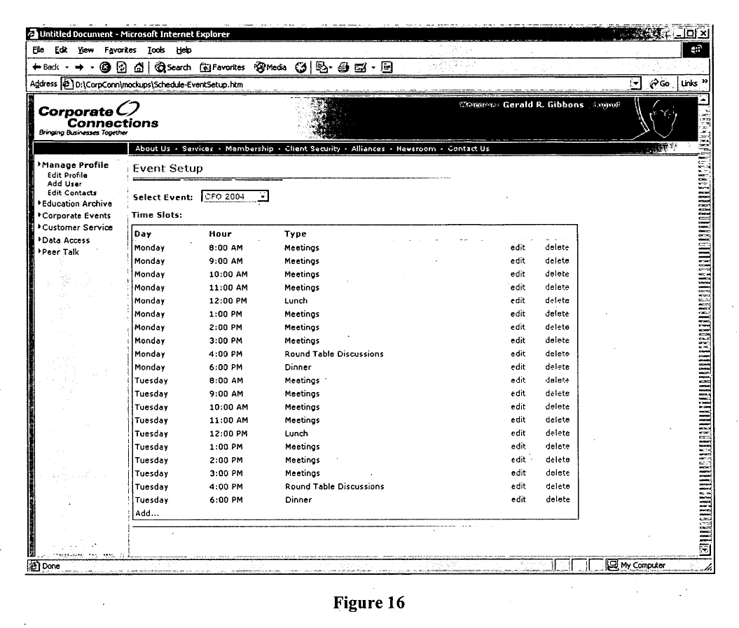

FIG. 16 is a screen shot of the portal page, showing the Event Setup Control display.

4.5.18 Agenda Edit Control

Purpose: Allows Corporate Connections Administrators to administer meetings based on Decision Maker's meeting requests. Where they have specified a specific company, the sponsor will already be filled in. If the have requested top N companies, a listbox is displayed where the administrator can assign sponsors that the decision maker will meet with.

Visible By: Corporate Connections Administrators

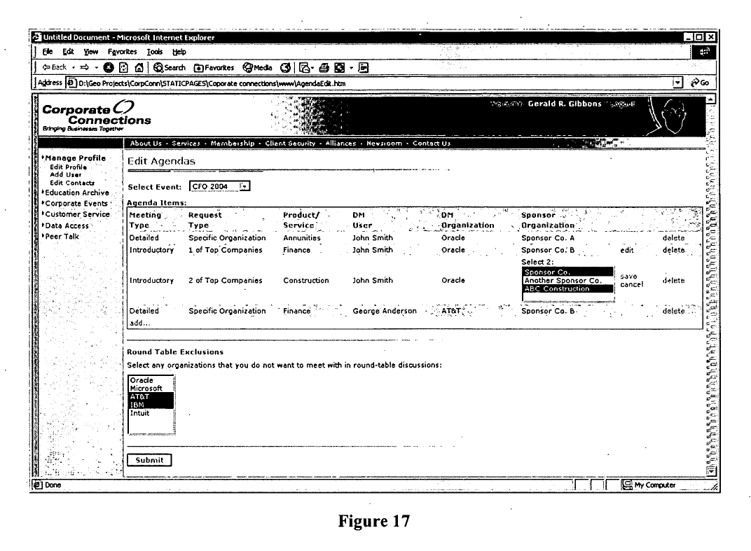

FIG. 17 is a screen shot of the portal page, showing the Agenda Edit Control display.

4.5.19 Sponsor Meeting Request Control

Purpose: Allows Event Registered Sponsors to select the Decision Makers that they would prefer to have join them at their dinner tables. Sponsors will select a number (4?) of 1^{st}, 2^{nd} and 3^{rd} choices for which they would like to dine with. These weightings will be used by the dinner scheduling module to try to match the most people up with their first choices.

Visible By: Event Registered Sponsors

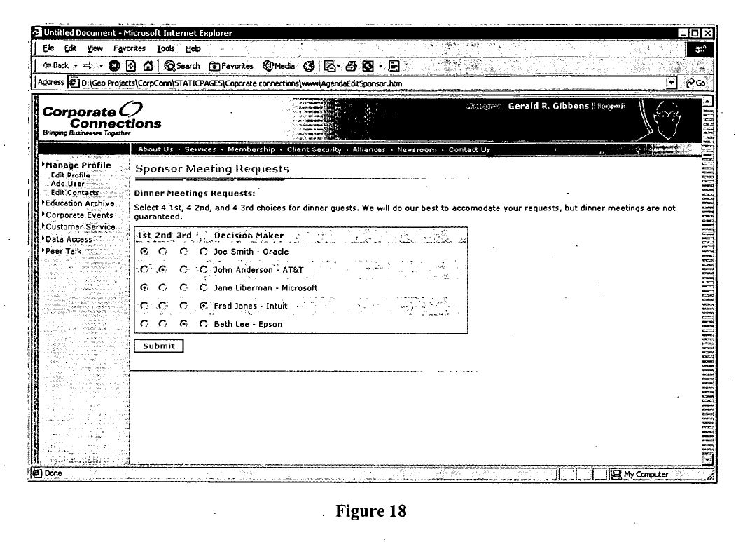

FIG. 18 is a screen shot of the portal page, showing the Sponsor Meeting Request Control display.

4.5.20 Agenda Confirmation Control

Purpose: Allows Decision Makers to view the meeting agenda and confirm meetings that have been set up for them. It also allows them to specify any companies that they do not wish to meet with in the round-table discussions.

Visible By: Event Registered Decision Makers

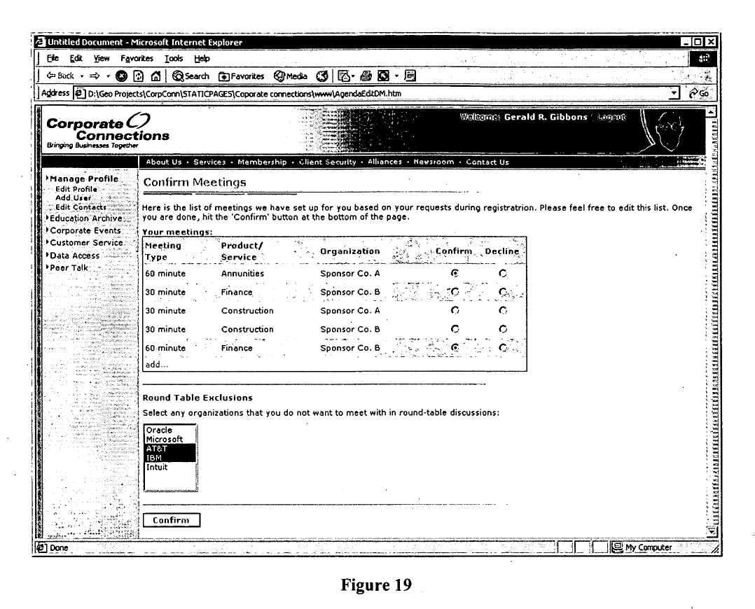

FIG. 19 is a screen shot of the portal page, showing the Agenda Confirmation Control display.

4.5.21 Schedule Import/Export Control

Purpose: Corporate Connections Administrators will be able to export Event Agendas and import optimized schedules using a schedule import/export tool. A mock-up of the interface to the tool is shown below. The user will select an event, and will browse to a file location to save the agenda too or to import the schedule from.

Visible By: Corporate Connections Administrators

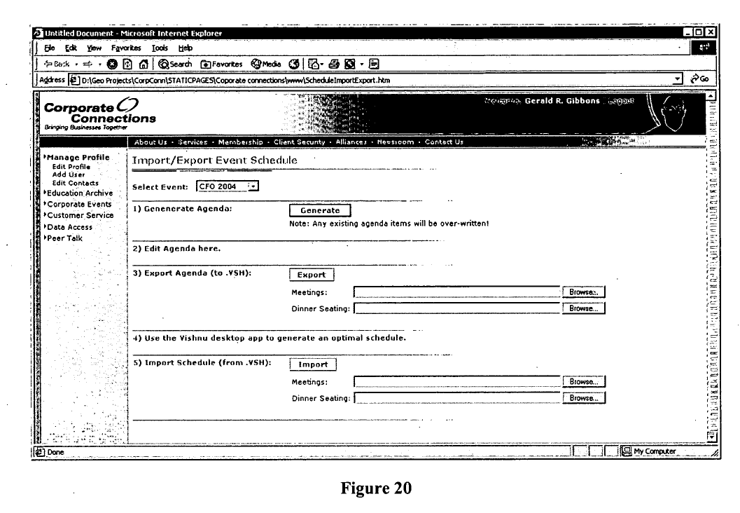

FIG. 20 is a screen shot of the portal page, showing the Schedule Import/Export Control display.

4.5.22 Round Table Administration Control

Purpose: Allows Corporate Connections Administrators to create round table discussion meetings, and manually select who will be in each meeting. The administrator selects a time slot from the list of round-table time slots assigned to the event (see the Event Setup Control). Administrators setup and populate the discussion meetings based partly on feedback from decision makers that was entered in the registration process.

Visible By: Corporate Connections Administrators

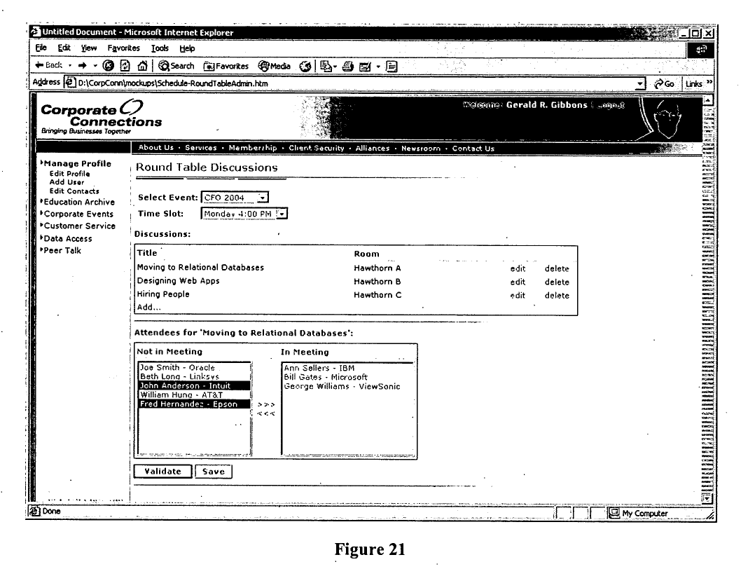

FIG. 21 is a screen shot of the portal page, showing the Round Table Administration Control display.

4.5.23 Dinner Table Meeting Administration Control

Purpose: Allows Corporate Connections Administrators to administrate dinner table meetings for each sponsor. Each table session for the sponsor will be shown, and the user will be able to assign an attendee to each table using a drop-down list. The dinner meeting requests made by the Sponsor will be shown (un-editable) to aid the Administrator in selecting Decision Makers for dinner meetings.

Visible By: Corporate Connections Administrators

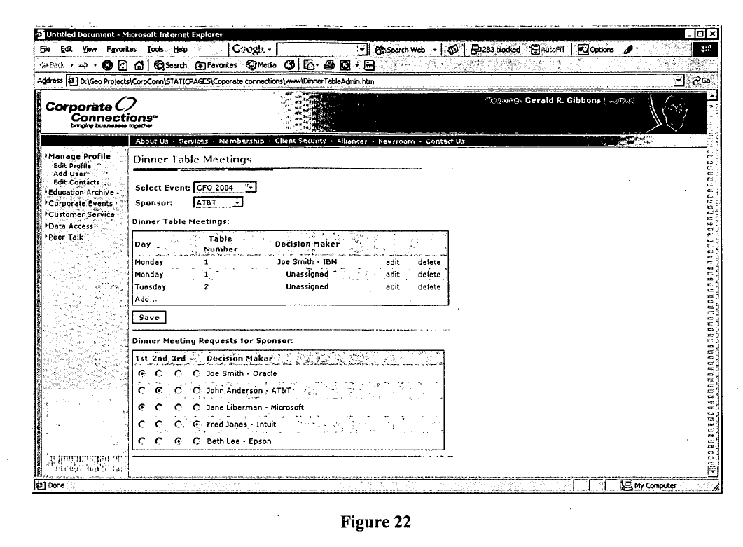

FIG. 22 is a screen shot of the portal page showing the Dinner Table Meeting Admin Control display.

4.5.24 Schedule Administration Control

Purpose: This page allows Administrators to add, delete and move meetings for an individual event attendee on a day-by-day basis. The existing meetings will be displayed, with buttons and drop-down lists to allow the addition of new meetings, or to move/delete existing meetings.

Visible By: Corporate Connections Administrators

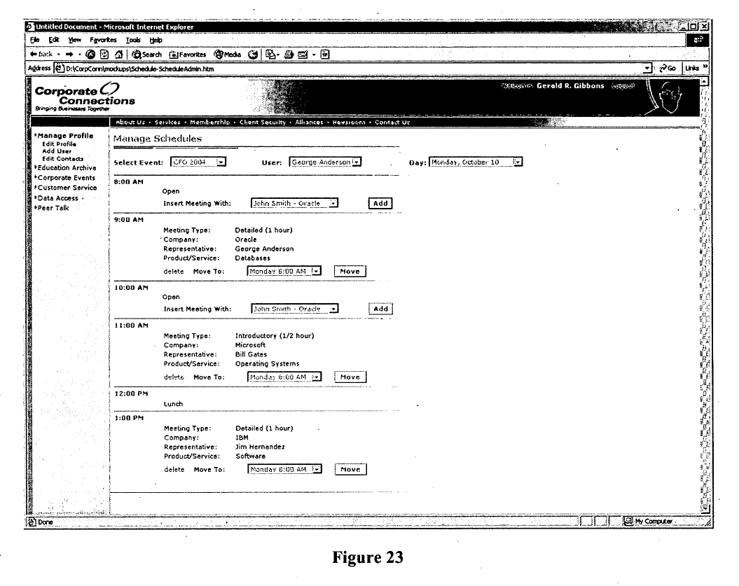

FIG. 23 is a screen shot of the portal page, showing the Schedule Administration Control display.

4.5.25 Schedule View Control

Purpose: This page allows users to view their event schedule (meetings, activities) on a day-by-day basis. This page will only be available to decision makers and sponsors after the event schedule has been generated.

Visible By: Event-Registered Decision Makers, Event Registered Sponsors

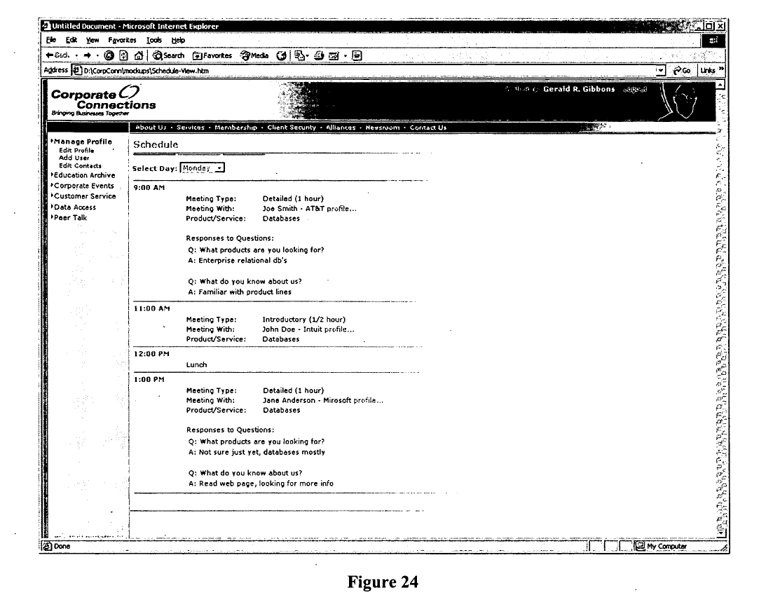

FIG. 24 is a screen shot of the portal page, showing the Schedule View Control display.

4.5.26 Salesforce Admin

Purpose: This control is used to setup the salesforce.com connection properties and to update the locally stored copy of the salesforce.com data. It allows the admin to edit the username and password of to allow connection to the salesforce.com webservice.

The administrator updates the local version of the salesforce.com data before reconciling the data in the corporate connection database.

Visible By: CCAdmin, Admin

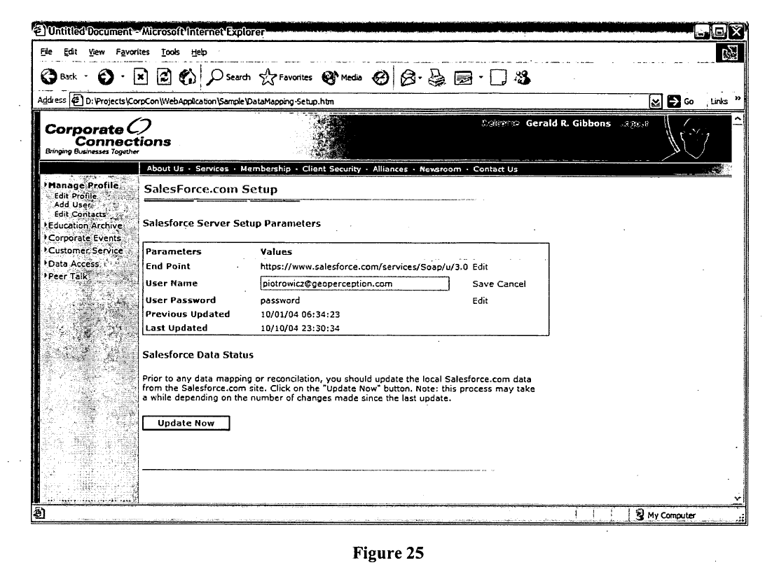

FIG. 25 is a screen shot of the portal page, showing the Salesforce.com—Setup display.

4.5.27 Salesforce Accounts to Orgs—Data Mapping

Purpose: This control is used to display the list of Accounts from Salesforce.com and map them to the equivalent Organization in the CorpConn Database. Each Organization record must be mapped to a salesforce.com record for a comparison to take place. If no matching organization is found the administrator has the option of creating a new record and copying the data over. If a record does not exist in the salesforce.com data, the administrator has to log in to salesforce.com and create a new record then map that record to the corporate connections data.

Visible By: CCAdmin, Admin

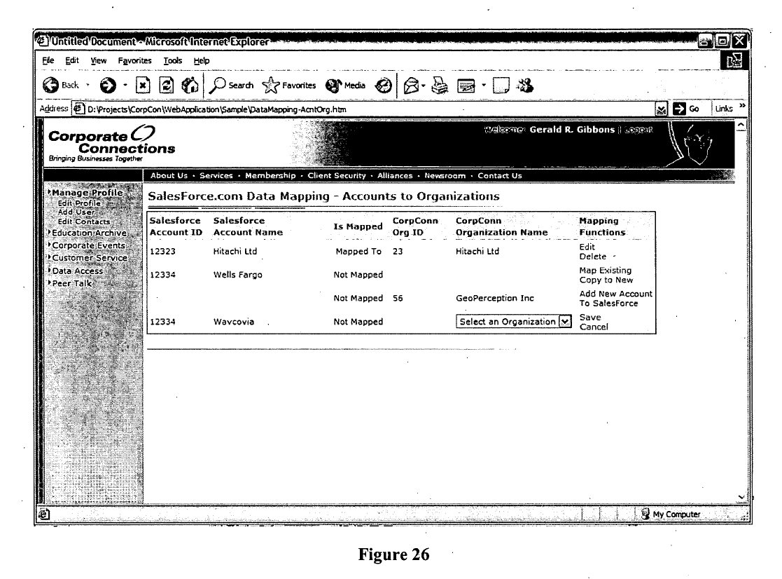

FIG. 26 is a screen shot of the portal page, showing the Salesforce.com—Accounts to Orgs display.

4.5.28 Salesforce Contacts to Users—Data Mapping

Purpose: This control is used to display the list of Contacts from Salesforce.com and map them to the equivalent Users in the CorpConn Database. If no matching User is found the administrator has the option of creating a new record and copying the data over. If a record does not exist in the salesforce.com data, the administrator has to log in to salesforce.com and create a new record then map that record to the corporate connections data.

Visible By: CCAdmin, Admin

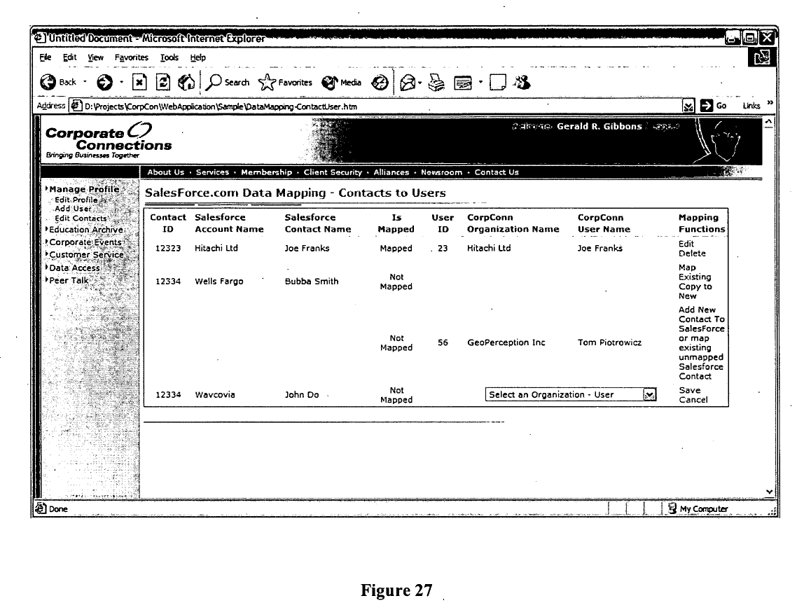

FIG. 27 is a screen shot of the portal page, showing the Contacts to Users display.

4.5.29 Salesforce Contacts to Users—Data Reconciliation

Purpose: This control is used to display the list of Contacts from Salesforce.com and compare them to the equivalent User in the CorpConn Database. If a difference in the data is found, the status reflects that. Some comparisons are made with fuzzy logic. Only mapped records are compared. The administrator can click on details to see all the comparable fields side by side. It may be perfectly valid to have differences in the data; this reconciliation process is left up to the discretion of the administrator.

Visible By: CCAdmin, Admin

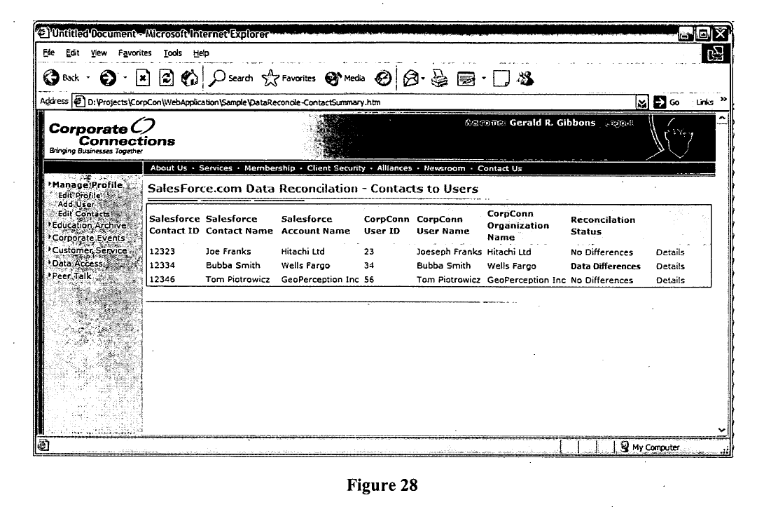

FIG. 28 is a screen shot of the portal page, showing the Salesforce.com—Reconcile Contacts to Users display.

4.5.30 Salesforce Accounts to Orgs—Data Reconciliation

Purpose: This control is used to display the list of Accounts from Salesforce.com and compare them to the equivalent Organization in the CorpConn Database. If a difference in the data is found, the status reflects that. Some comparisons are made with fuzzy logic. Only mapped records are compared. The administrator can click on details to see all the comparable fields side by side. It may be perfectly valid to have differences in the data; this reconciliation process is left up to the discretion of the administrator.

Visible By: CCAdmin, Admin

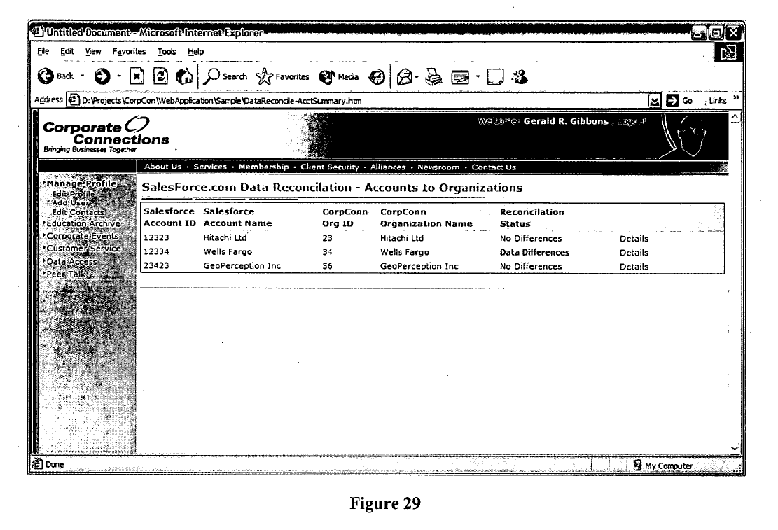

FIG. 29 is a screen shot of the portal page, showing the Salesforce.com—Reconcile Accounts to Orgs display.

4.5.31 Salesforce Contacts to Users—Data Reconciliation Detailed

Purpose: This control is used to display the comparable fields of a specific Contact from Salesforce.com and compare them to the equivalent User in the CorpConn Database. Only mapped records are compared. The administrator can click to copy data from one side to another, or they can edit the records manually. The format of the data may vary between datasets, so there is extra logic in the controls to check formats and remove formatting before comparisons are done.

Visible By: CCAdmin, Admin

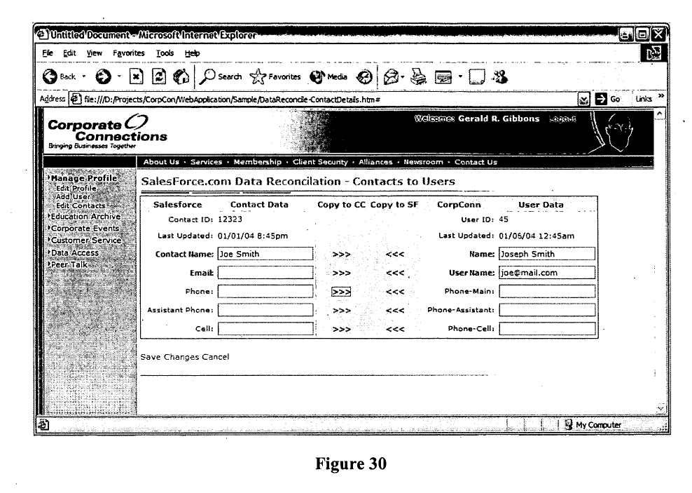

FIG. 30 is a screen shot of the portal page, showing the Salesforce—Contact to Users—Detailed display.

4.5.32 Salesforce Accounts to Orgs—Data Reconciliation Detailed

Purpose: This control is used to display the comparable fields of a specific Account from Salesforce.com and compare them to the equivalent Organization in the CorpConn Database. Only mapped records are compared. The administrator can click to copy data from one side to another, or they can edit the records manually. The format of the data may vary between datasets, so there is extra logic in the controls to check formats and remove formatting before comparisons are done.

Visible By: CCAdmin, Admin

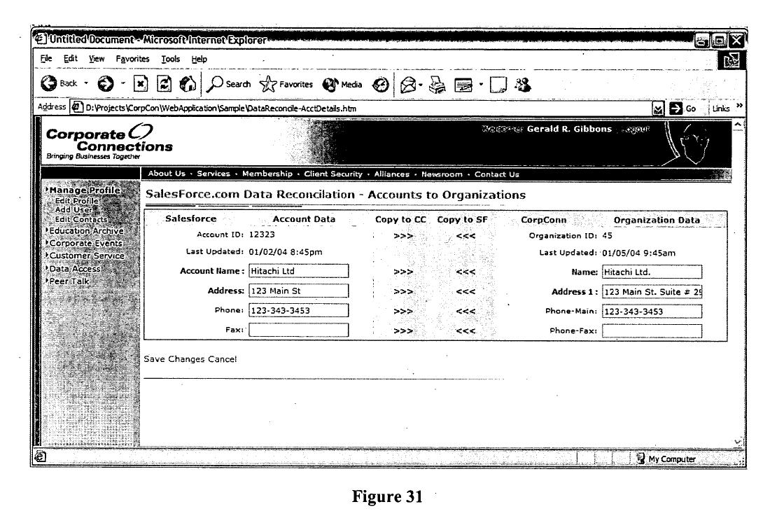

FIG. 31 is a screen shot of the portal page, showing the Accounts to Orgs—Detailed display.

4.5.33 Admin—User and Org Bios

Purpose: This control is used to list the status of user and organization bio information and allow the administrator to create and edit this information and upload attachments. When the user clicks on the Edit or Create they are navigated to the edit page for the user or organization that they selected.

Visible By: CCAdmin, Admin

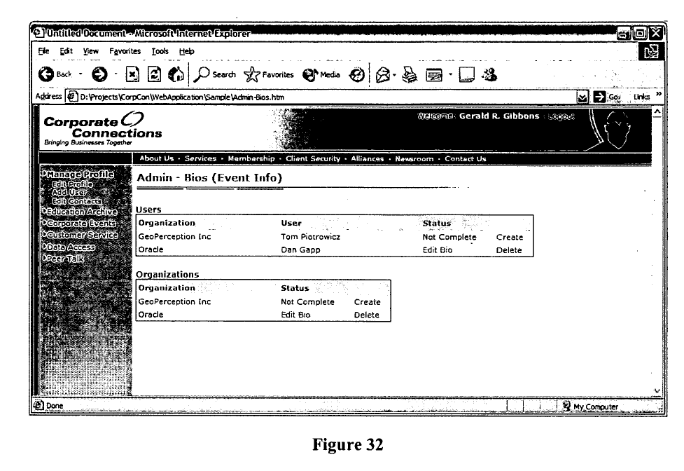

FIG. 32 is a screen shot of the portal page, showing the Admin—User and Org Bios display.

4.5.34 Admin—User and Org Bios Edit

Purpose: This control is used to edit user and organization bio information and allow the administrator to upload attachments for the bio. These attachments can include company prospectus or images of the user; and the attachments can be in word, pdf, jpg, gif or bmp.

Visible By: CCAdmin, Admin

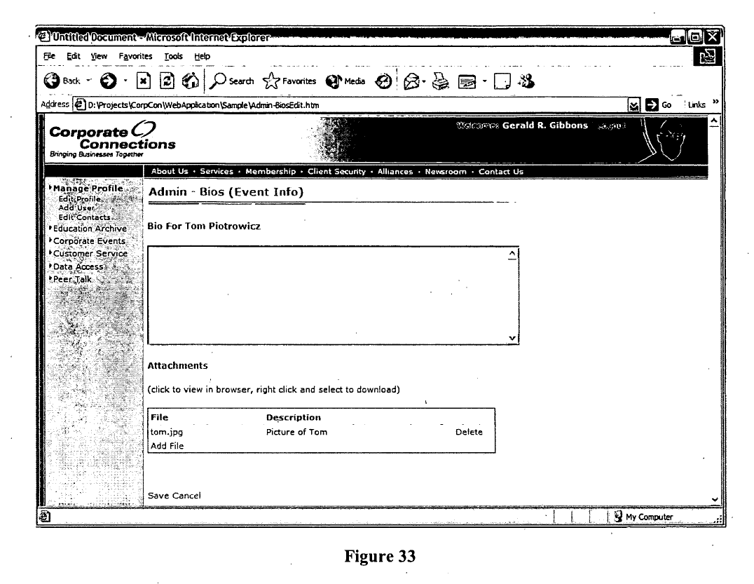

FIG. 33 is a screen shot of the portal page, showing the Admin—Bio Edit display.

4.5.35 Admin—Post Meeting Surveys

Purpose: This control is used to edit the surveys that are presented to users during an event. Currently there is a post meeting sponsor survey, a post meeting decision maker survey, meal meeting surveys, panel discussion surveys, speaker surveys, and a post experience exchange survey. The user selects the event and then click the edit button to edit the survey.

Visible By: CCAdmin, Admin

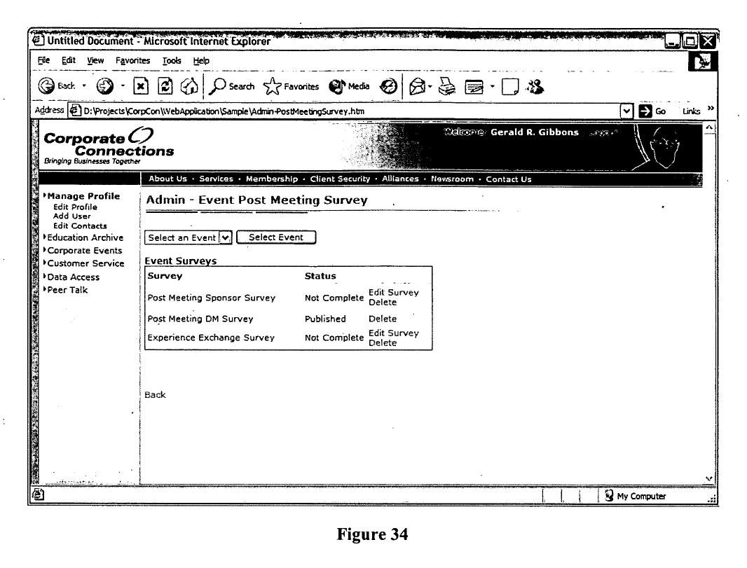

FIG. 34 is a screen shot of the portal page, showing the Admin—Surveys display.

4.5.36 Admin—Post Meeting Survey Edit

Purpose: This control is used to edit a post meeting survey that is presented to users during an event. The admin is able to edit or delete questions and then edit the question options. Once the survey is complete the admin publishes it to the event, which prevents any further edits to the survey.

Visible By: CCAdmin, Admin

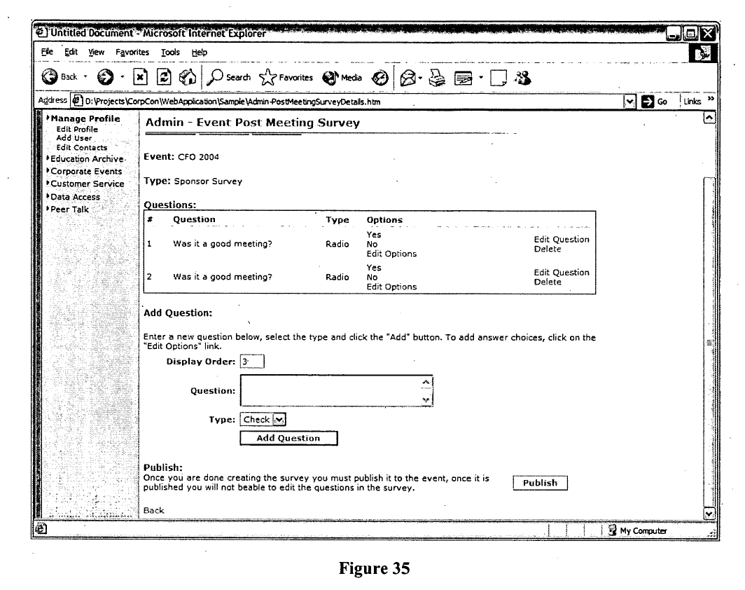

FIG. 35 is a screen shot of the portal page, showing the Admin—Survey Edit display.

4.5.37 Admin—Sponsor Details

Purpose: This control is used by admin to view/edit details of a sponsor for an event. This page is very similar to the Sponsor Admin page and allows the admin to assist the sponsor in setting up all the required information for an event.

Visible By: CCAdmin, Admin

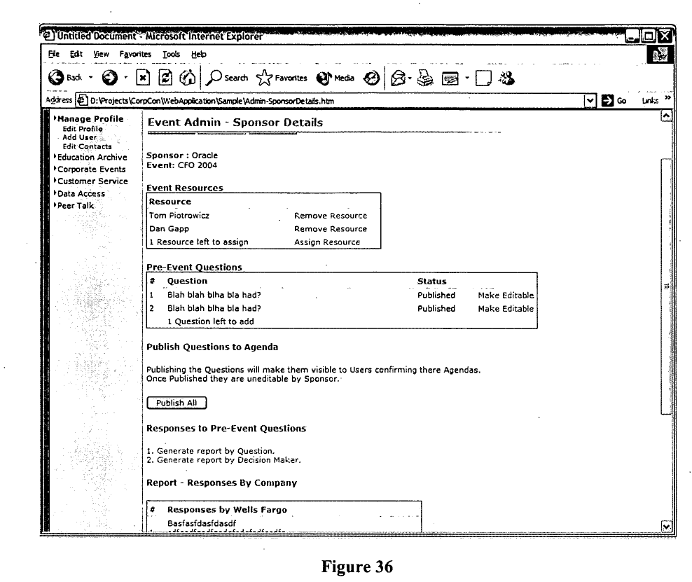

FIG. 36 is a screen shot of the portal page, showing the Admin—Sponsor Details display.

4.5.38 Sponsor—Admin

Purpose: This control is used by sponsors to view/edit details of their membership. It allows the sponsor admin to manage events and resources that can be assigned to events. First the sponsor can create other users or resources that can be assigned to attend meetings at an event, and then they can click to view the details of the event and can assign those resources that event.

Visible By: CCAdmin, Admin

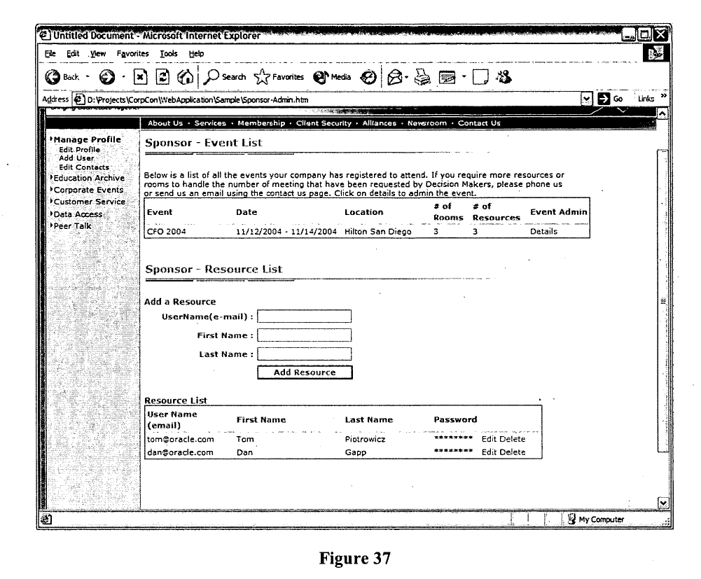

FIG. 37 is a screen shot of the portal page, showing the Sponsor—Admin display.

4.5.39 Sponsor—Event Admin

Purpose: This control is used by Sponsor Administrators to view/edit details of an event that they have paid to attend. It allows the Sponsor Administrators to assign resources to the event and create premeeting questions for Decision Makers to answer. Then they can generate a report of the answers provided by the DMs to help them prepare for their meetings.

Visible By: Sponsor Administrators

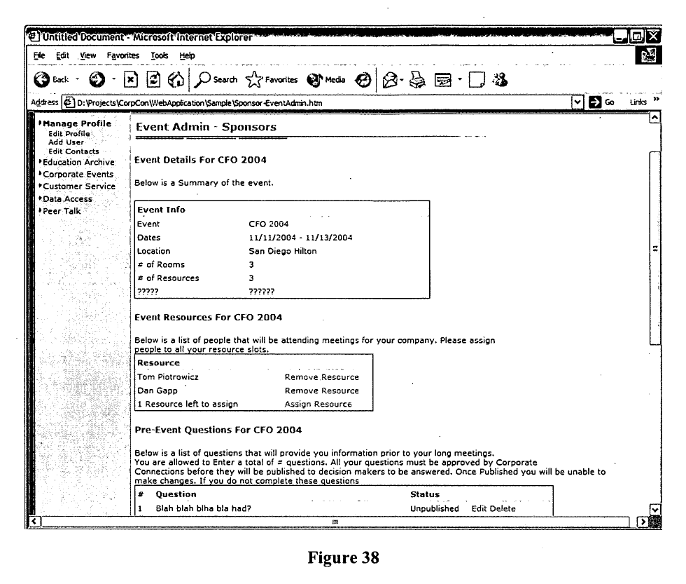

FIG. 38 is a screen shot of the portal page, showing the Sponsor—Event Admin display.

4.6 Portal Configuration and Use Guidelines

4.6.1 Where Possible Use Existing Portal COMPONENTS

Reuse existing portal components when ever possible, for example the HTML component to display HTML or text on a page.

4.6.2 Each Event Gets its Own Tab Under the Events Tab

This will provide a greater marketing punch, it will let users see what events are out there but they will get a friendly message if they are not invited or attending the event.

4.6.3 Each Event has to be Mapped to the Event Tab in the Web.config

This is so that we can redirect the user to the proper event on initial login.

5 Data Model

5.1 Overview

Data that is required to operate the portal page of the web site of the illustrated embodiment is stored in a SQL Server 2000 database. This database contains information on site layout, site content, user rights and specific portal component data. The Rainbow portal already has a data-model that will be used as a base. This data-model has been modified and enhanced to meet the data requirements for the preferred system configuration.

5.2 Scheduling Tables

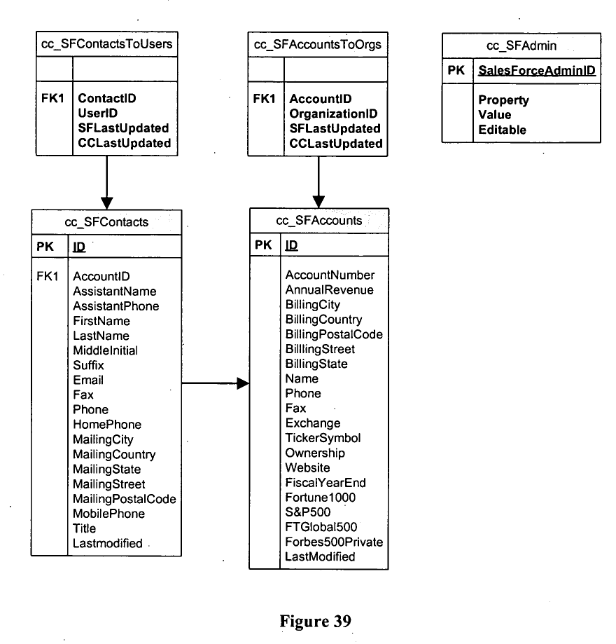

FIG. 39 is a data diagram of the Scheduling portion of the database model.

5.3 SalesForce.com Modifications

FIG. 39 is a data diagram of the Scheduling portion of the database model.

Joins to existing database by [rb_Users].[UserID]=[cc_SFContactsToUsers].[UserID] and [cc_Organizations].[OrgianizationID]=[cc_SFAccountsToOrgs]. [OrganizationID]

5.4 Admin Modifications

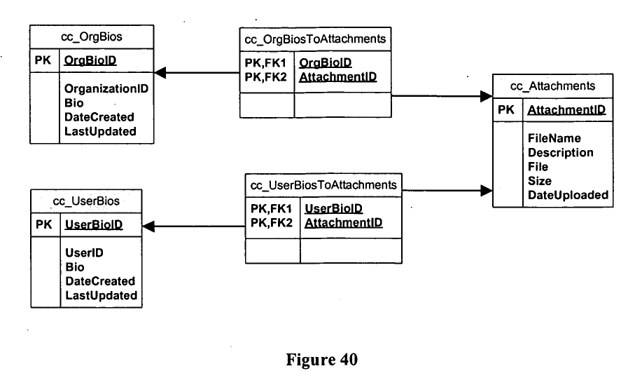

FIG. 40 is a data diagram that illustrates the modified Admin portion of the database model, showing how the Admin portion joins to existing database by [rb_Users].[UserID]=[cc_UserBios].[UserID] and [cc_Organizations].[OrgianizationID]=[cc_OrgBios].[OrganizationID]

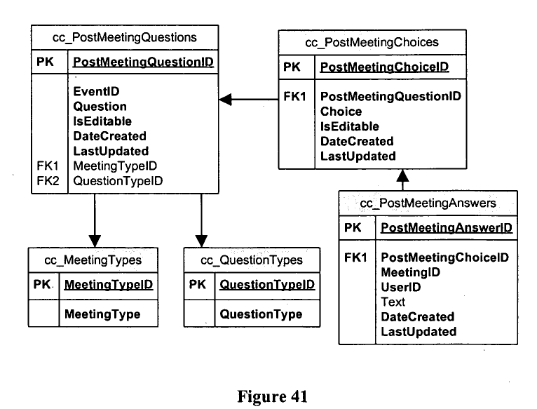

FIG. 41 is a data diagram that shows how the data joins to existing database by [cc_Events].[EventID]=[cc_PostMeetingQuestions].[EventID] and [cc_Meetings].[MeetingID]=[cc_PostMeetingAnswers].[MeetingID]

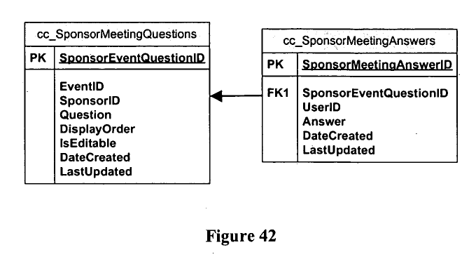

FIG. 42 is a data diagram that shows how the data joins to existing database by [cc_Events].[EventID]=[cc_SponsorMeetingQuestions].[EventID] and [cc_OrganizationID].[OrganizationID]=[cc_PostMeetingAnswers].[SponsorID]

and [rb_Users].[UserID]=[cc_SponsorMeetingAnswers].[UserID]

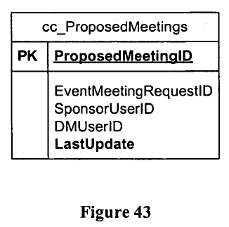

FIG. 43 is a data diagram that shows how the data joins to existing database by [cc_EventMeetingRequests].[EventMeetingRequestID]=[cc_ProposedMeetings].[EventMeetingRequestID] And [rb_Users].[UserID]=[cc_ProposedMeetings].[SponsorUserID] And [rb_Users].[UserID]=[cc_ProposedMeetings].[DMUserID].

(Note that columns are NULLABLE in cc_ProposedMeetings)

This table is used to hold proposed meetings (agenda items) after registration is closed, but before the initial schedule is generated. It will be initially populated through a one-time SQL query (in future versions of the software this will be managed through an admin interface).

5.5 Mobile Scheduling Modifications

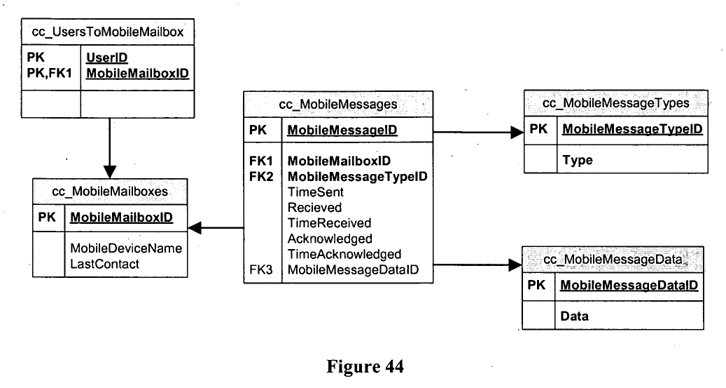

FIG. 44 is a data diagram that shows how the modified Admin portion of database model joins to the existing database by [cc_UsersToMobileMailbox].[UserID]=[rb_Users].[UserID].

6 Mobile Scheduling

6.1 Purpose

The Corporate Connections system is a powerful tool for managing complex business schedules dynamically. But the fact that schedules are dynamic creates the need for meeting attendees to be notified of the changes as they are made. The Mobile Scheduling portion of the Corporate Connections system is a user-friendly and easy to use method of distributing schedules to attendees, automatically.

The Mobile Scheduling System consists of an application server, some software to run on the web server application, and a PDA running special client software on Windows CE. The user will be reminded by sound and display of upcoming meetings, and will be able to review their schedules as they are updated.

6.2 Overview

The Corporate Connections system takes advantage of Microsoft Windows Mobile 2003 networking and software interface features in order to provide an easy-to-use, seamless meeting notification system for conference attendees.

PDA clients communicate with the web server via HTTPS. The PDA clients are connected to the internet through the wireless network provided by the conference center. Client software installed on the PDA's reads messages in the form of XML data returned by the Corporate Connections server and sets up the Attendees schedule. The client software also takes care of meeting notifications and post-meeting surveys.

6.2.1 Use Cases

6.2.1.1 Network Administrator

The Corporate Connections system has a “loose” connection to an email server. The system does not need to be in direct contact with the email server it uses. Also, any email server can be used with the system. This loose coupling requires the Network Administrator to create email accounts manually, and for him or her to enter those email accounts into the Corporate Connections system.

Ideally, this is a one-time setup. Email addresses can be added or removed for maintenance.

Another duty of the Network Administrator is to check and test the wireless network at the conference site. The basic parameters of each conference site are bound to be different, and the Network Administrator must enter the correct setup parameters into the web site. This makes the job of the personnel setting up the mobile devices much easier and less technical.

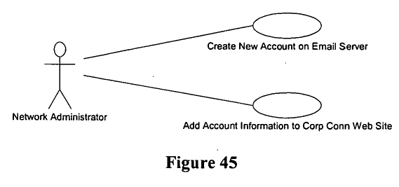

FIG. 45 is a data flow diagram that illustrates processing of the Network Administrator Use Case—Creating Email Addresses

6.2.1.2 Corporate Connections Administrator

A Corporate Connections Administrator has the duty of setting up the PDA devices well before the start of the conference. This is a fairly simple but time-consuming process. Each PDA needs to be setup individually. The first duty will be to install the Corporate Connections Client software on the device. Next, the Administrator must go to the PDA deployment pages, starting with User Setup, and assign an email address to the PDA user. Next, the Administrator navigates to the PDA setup page and follows the detailed instructions, which includes setting up the networking and email based on what the Network Administrator has entered previously.

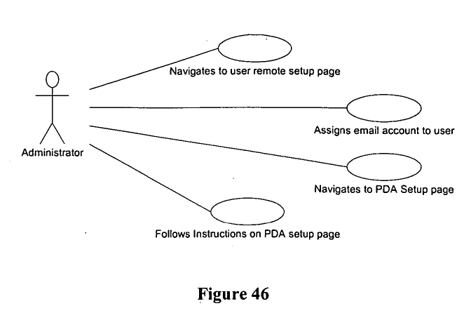

FIG. 46 is a data flow diagram that illustrates processing of the PDA Preparation Use Case.

6.2.1.3 Attendee

The Attendee's user experience is a straightforward and simple one. When an attendee receives a new schedule, a particular alert informs him to check his schedule. The attendee will be able to review his schedule within the built-in calendar on the PDA device.

When a meeting time grows close, the Attendee will be notified with another sound as well as text and links providing him details about the upcoming meeting. When meetings draw to a close, the user will be presented with a survey form to provide feedback for Corporate Connections.

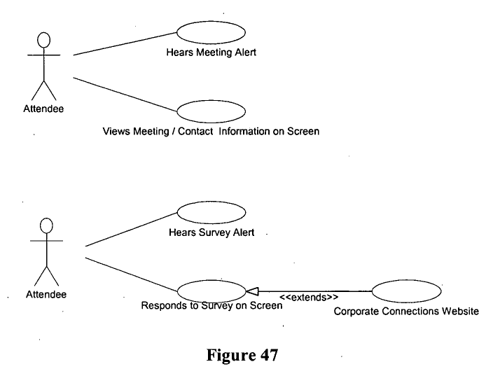

FIG. 47 is a data flow diagram that illustrates processing of the Attendee Use Cases.

6.3 Design

6.3.1 Detailed Software Design Overview

The Mobile Scheduling portion of the Corporate Connections system contains three server software components. The Remote Device Manager component contains all the business logic that resides on the server concerning remote communications, messages, and message formatting. The Remote Device Manager also has interfaces to communicate with, schedule, and check status of each user.

Another software component exists on the mobile devices themselves. The Corporate Connections Mobile Client software brings the end user a unique user experience that emphasizes ease of use.

These software components are discussed in detail in the following sections.

6.3.2 Network Design

The networking necessary for the Mobile Scheduling portion of the Corporate Connections system is not complex. The Corporate Connections system has a dedicated SMTP/POP3 e-mail server that is accessible from the internet.

The mobile devices communicate to the internet through a WAP, or Wireless Access Provider. The WAP device may be owned and operated either by the conference host site or by Corporate Connections itself. Regardless of the owner and operator, the WAP must allow access to the internet via a IEEE 802.11b wireless connection.

Mobile Networking

Prior to each event, a Corporate Connections Web Site administrator retrieves all the relevant networking information from the corresponding administrator at the conference site. That information is then entered into the Corporate Connections site via the Mobile Administration Web Pages.

6.3.3 Communications and Message Formats

Communication takes place between the Server and Clients by use of HTTPS post requests made by the clients. This removes the network complexity and cost that can come with deploying an Exchange Server as the primary mode of communication. The client's post request contains one or more commands. The server responds to the post request with the resultant data in the form of XML encoded messages. The messages and commands that are sent back and forth between server and clients contain information that is specific to the application. Depending on the information contained within the body of the email message, the message falls into one of five categories. Three commands types can be sent to the server. Four message types are returned to the mobile user's PDA.

The outgoing (Server to PDA) messages include:
Schedule messages contain xml data that represents a user's daily schedule for the event.
Alert messages cause a special alert message to appear on the PDA
Survey messages contain a hyperlink of a survey on the internet
Status messages are sent to provoke an acknowledgment email from the device.

The incoming (PDA to Server) messages include:
Acknowledge commands are sent by the client as a response to each of the above server-generated messages.
Register commands are sent by the client as to create a mobile mailbox for a user, based on user information entered on the mobile device.
GetMessages commands get all the unacknowledged messages from the mobile mailbox data store and package them into XML.
   6.3.3.1 Message Wrapper Format

Several messages may be sent to the mobile unit at one time. The message wrapper is a simple XML tag that contains all the messages for that user.

<CorpConnMsgs>
<CorpConnMsg/>
<CorpConnMsg/>
...
</CorpConnMsgs>

6.3.3.2 Schedule Message Format

A message containing schedule information identifies itself with the word “CCSchedule” in the subject text of the message. Also, the Schedule message contains XML data in the text body of the message. The XML format for a Schedule Message is as follows:

```
  <CorpConnMsg type=“Schedule”>
    <Notification notifyTime=“10” />
    <Schedule month=“11” day=“14” year=“2004”>
      <Appointment hour=“22” minute=“0” length=“60”>
        <Location>
        Dakota Room - Grand Plaza Conference Center
        </Location>
        <ContactList>
          <Contact>
            <Person
url=“http://www.corpconn.com?user=2314”>
            John W. Smith
            </Person>
            <Company
url=“http://www.corpconn.com?company=0993” >
            BigWig Hair Replacement
            </Company>
          </Contact>
          ...
        </ContactList>
      </Appointment>
      ...
    </Schedule>
  </CorpConnMsg>
```

6.3.3.3 Alert Message Format

An alert message identifies itself with the word “CCAlert” in the subject text of the message. The e-mail body contains XML data in the following form:

```
<CorpConnMsg type=“Alert”>
    <Alert>
        Please report to the Corporate Connections Booth Immediately.
    </Alert>
</CorpConnMsg>
```

6.3.3.4 Survey Message Format

A survey message identifies itself with the word “CCSurvey” in the subject text of the message. The e-mail body contains XML data in the following form:

<CorpConnMsg type=“Survey”>
<Survey month=“11” day=“14” year=“2004” hour=“22” minute=“00”
url=“www.corpcon.com?survey=9”/>
</CorpConnMsg>

6.3.3.5 Status Message Format

A message requesting a status acknowledgment identifies itself with the word “CCStatus” in the subject text of the message. The e-mail body is ignored.

6.3.3.6 Acknowledge Message Format

An acknowledgment message identifies itself with the word “CCAck” in the subject text of the message. In addition, the body text contains the XML of the following structure:

<CorpConnMsg type=“Acknowledge”>
<Acknowledge month=“11” day=“14” year=“2004” hour=“22”
minute=“16” MsgType=“CCStatus”/>
</CorpConnMsg>

6.3.4 Mobile Administration Web Pages

A subsection of web pages on the Corporate Connections site allows the Mobile Administrator to enter critical web security and networking settings into the site, where they will are referenced later to assist in the configuration of Mobile PDA devices.

There are two main configuration subsections. The first concerns the local wireless network settings that were collected from a particular conference site. The second page displays the current status of the Mobile users. Both pages connect to the Remote Device Manager Component to save information in the database.

6.3.4.1 Wireless Networking Setup

The Wireless Networking Setup pages are essential to the proper and speedy deployment of the mobile PDA devices. Well before a conference occurs, a Corporate Connections Mobile Administrator will obtain all the proper wireless network settings from a network administrator at the host site. Once those settings have been validated, the Mobile Administrator must enter them into the Corporate Connections site via the Wireless Networking Setup pages.
Wireless Access Point Page
IP Settings Page
Proxy Settings Page
DNS Settings Page
   6.3.4.2 Mobile Status Page

The Mobile Status Page is a useful tool to isolate problems certain users or devices might be having. It is a tool that should be used regularly at each conference, to ensure that each Attendee is getting the proper user experience.

The Mobile Client Software is built to send acknowledgements to each of the messages sent to it. The Mobile Status page is a report that displays the current status of each user's device, highlighting the users whose device has not been heard from. An individual status message can also be sent from this page, to verify the status of a particular user.

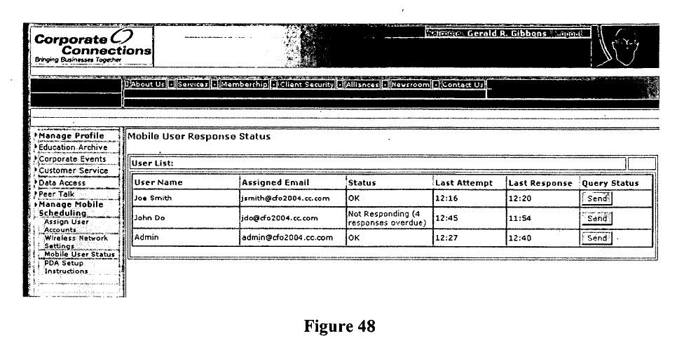

FIG. 48 is a screen shot that shows the Mobile Status Page of the illustrated embodiment.

6.3.4.3 PDA Setup Instruction Web Pages

A small subsection of web pages exist on the main website to ease and speed up the process of configuring the PDA devices pre-show. The pages reflect information entered by a site administrator on the PDA Administration Web Pages. The Setup Instruction Pages provide a step-by-step guide that allows even a novice to begin quickly setting up PDA devices to work with the Corporate Connections system.

Information that is presented on the PDA Setup Instruction Pages include:
Enabling WLAN, configuring WLAN security settings for the event location's hardware
Registering the attendee on the mobile device
Editing default settings that must be changed
Installing the PDA Client Software
Test procedure
   6.3.5 Remote Device Manager Component

The Remote Device Manager contains the business logic layer for associating Corporate Connections users and their schedules with mobile PDA devices. The Remote Device Manager connects to the User Database to associate users with the email addresses with which they will communicate with the system. The Remote Device Manager calls functionality from the Messenger component in order to communicate with the remote devices. It also produces XML message bodies for the 5 message types that will be sent to the mobile units. The Remote Device Manager is a .NET component written in C#.

6.3.5.1 Interface Functions

AddEventWLANParameters([in]Int EventID, [out]Int WlanID, [in] String WAPName, [in]Boolean Encrypted, [in]Boolean SharedNetAuthentication, [in]Boolean AutomaticKey, [in] String NetworkKey, [in]String KeyIndex)—Sets the WLAN connection parameters for a particular event site. These values appear on the PDA setup html pages.

RemoveEventWLANParameters([in]Int WLanID)—Removes a set of WLAN connection parameters for a particular event site.

GetWLANParametersXml([in]Int EventID [out] String WAPName, [in]Boolean Encrypted, [in]Boolean SharedNetAuthentication, [in]Boolean AutomaticKey, [in] String NetworkKey, [in]String KeyIndex)—Gets an Xml document that lists the Wlan setup records associated with a particular event site.

BuildUserXmlSchedule([in]Integer UserId, [out] String XmlSched)—Transforms the user's schedule from the database into an XML format which can be ready by the PDA's.

SendSchedule([in]Integer UserId)—Adds a Schedule message to the user's Mobile Mailbox, with a payload of BuildUserXmlSchedule

SendStatus([in]Integer UserId)—Adds a Status message to the user's Mobile Mailbox. Updates the database record to indicate when last status message was sent.

SendAlert([in]Integer UserId, [in] String Body)—Adds an Alert message to the user's Mobile Mailbox, with an XML payload of AlertBody.

SendSurvey([in]Integer UserId, [in] String Body, [in] String Hyperlink)—Adds a Survey message to the user's Mobile Mailbox, with an XML payload of Survey type.

GetUserMobileStatusXml([in]Integer UserId, [out] String StatusXml)—Reads the User's status from the corresponding Mobile Mailbox data table.

GetAllMobileStatusXml([in]Integer EventId, [out] String StatusXml)—Reads the all the Users' from the Mobile Mailbox data table.

6.3.6 Mobile Response Object

The Mobile Response Object is a NET page service that accepts commands posted to it via HTTPS by the Corporate Connections Mobile Client Software. In response to the commands it received, the Mobile Response Object accesses data from the database and call functionality of the Remote Device Manager.

6.3.6.1 Interface Functions

GetMessages([in]String UserName, [out]String XmlMessages)—Creates a nested XML document containing outgoing message based on all the MobileMessages that have not been acknowledged for that user. Marks all such messages as received in the database.

RegisterUser([in]String UserName, [in] String PDAName)—Creates a new Mobile Mailbox associated with the supplied user.

AcknowledgeMessages([in]String UserName, [in]String MessageldList)—Parses a list of comma-separated message id's and marks them all as Acknowledged.

6.3.7 PDA Client Software

The PDA Client Software is a C#.NET application built for Windows Mobile 2003 (aka Windows CE.NET 4.2). The Corporate Connections PDA Client Software Client takes advantage of two key Microsoft technologies on CE.NET devices: MAPI (Mail Application Programming Interface), which allows applications to send and receive email, and POOM (Pocket Outlook Object Model), which provides a mechanism to edit the calendar and appointments.

The PDA client is set up to run continually on the attendee's PDA mobile device. The software periodically polls the inbox of the device, looking for e-mails. When new e-mails arrive that conform to the Corporate Connections types (Schedule, Alert, Survey, and Status), the software takes the appropriate action. Once the message has been processed, the client software sends a return e-mail to the server as an acknowledgment. After processing e-mails, the client software will then inspect the Calendar for upcoming appointments. If an appointment is imminent, display a reminder dialog and play the sound specifically created for the Reminder function.

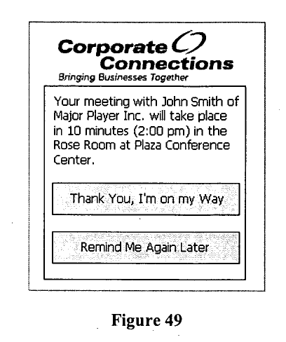

FIG. 49 is a screen shot that shows the Reminder Screen with Sample Text.

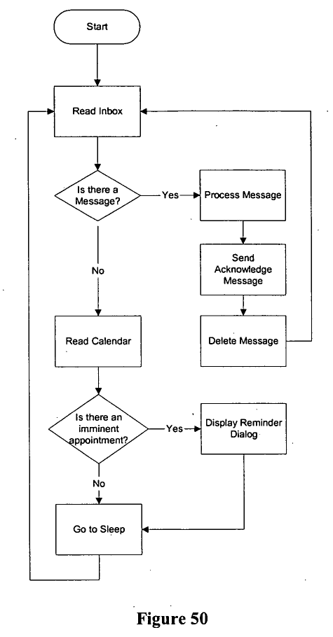

FIG. 50 is a flow diagram that shows the PDA Client Software Flow.

The client software performs the following function based on the message received:

Status: Send an Acknowledge message to the sender of the message.

Alert: Play a sound created specifically for the Alert function. Display a dialog that contains the message text embedded in the Alert XML data. Send an Acknowledge message to the sender of the message.

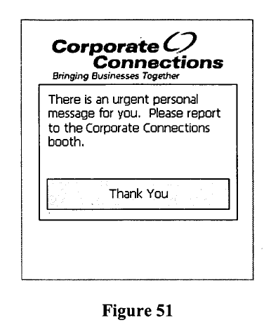

FIG. 51 is a screen shot that shows the Alert Screen with Sample Text.

Survey: Play a sound created specifically for the Survey function. Display a web browser and direct the browser to the url contained in the Survey XML data. Make web browser persistent, requiring the user to fill out the survey before performing any other function on the device. Send an Acknowledge message to the sender of the message.

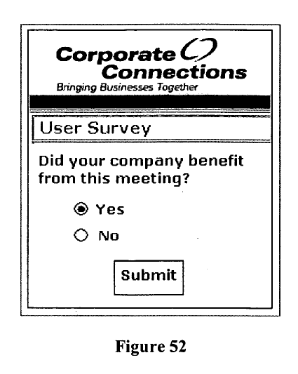

FIG. 52 is a screen shot, such as will be displayed on the PDA screen of an attendee, that shows a Survey Screen with Sample Survey.

Schedule: Iterate through the Appointment nodes stored in the Schedule XML data embedded in the message. For each Appointment node, add an appointment to the Calendar program that resides on the PDA. Send an Acknowledge message to the sender of the message.

6.3.7.1 PDA Client Install Program

A simple installation program is provided for ease of use in configuration of the PDA's. The install program requires that the PDA be connected to a Windows PC via USB cradle and Microsoft ActiveSync 3.7.

6.4 Communication Workflow

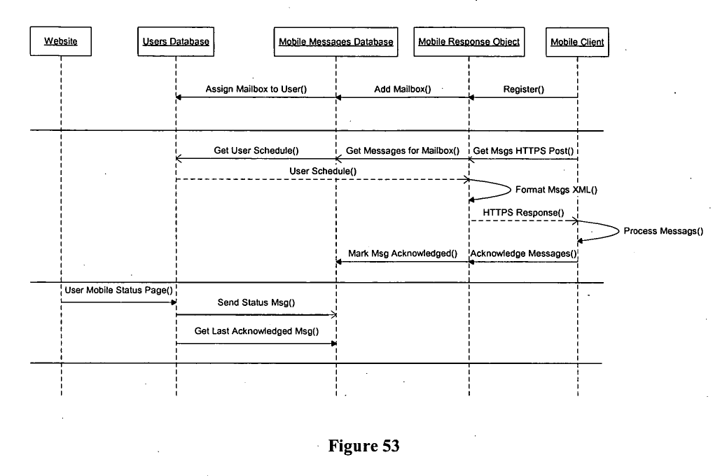

FIG. 53 is a data flow diagram that provides a Communication Sequence Chart showing how the web site, database, and mobile devices interact with each other.

7 Features

In accordance with embodiments of the invention described herein, a number of features are provided for improved business introductions. The features include the following:

1. Enhanced business directory used as a targeted senior executive business resource and to select meetings based on their profile, which highlights their uncommitted business initiatives. A network datastore contains such attendee profile information.

2. User interface to directory is customized to reflect appropriate items to a specific senior executive position including vernacular, category groupings and sub-category items. The user interface, and the other system processing, are provided by a system data processor, which can be one or more network computers that can share data and processing tasks.

3. Data by company is mapped for all dimensions of each individual business unit, the products and services each sells and who their ideal customers are, as well as their national or regional territories and who runs each unit.

4. Relational characteristics and social networking (6-degree separation) approaches are utilized to enhance connection identification within business directory.

5. Targeted senior executive uncommitted business initiatives are used to arrange meetings with senior executives of applicable national/regional vendor companies creating proper alignment for all meetings.

6. Vishnu scheduler is used to determine optimal schedules for all meetings at a Connection Meeting based on several priority factors that can be averaged or used in sequence such as: (i) the degree of match between targeted senior executive product/service request and vendor company profile including their product/service offerings, geographical area of service, and their desired target company attributes, e.g.: $1 billion or more in annual revenue, 10,000 or more employees, etc., (ii) amount sponsor is paid, (iii) if sponsor is a single or multi-meeting sponsor, (iv) should this be a private meeting or a meal meeting, (v) potential future value of sponsor to Corporate Connections.

7. Schedules for all attendees of a Connection Meeting are downloaded into a handheld PDA device that also are linked to applicable personal and company data and images that can be accessed at any time and e-mailed to their office.

8. PDA sends out alerts for activity changes and forces user to provide real-time survey data at the conclusion of each activity to assess the value of each.

9. The PDA application is capable of real-time communication between scheduled meeting participants and other attendees of the Connection Meeting, allowing meetings to be changed, proposed, and confirmed with or without administrative assistance and immediately alerting all impacted parties while updating all applicable records.

10. Experience Exchange sessions are arranged based on company ownership and annual revenues, and no-conflict among group participants are confirmed prior to Connection Meeting via technology, as well as providing bios and detailed contact information on each session member. Survey data and post session questionnaire feedback are collected via PDA and archived. Future groupings may also be segregated by items such as industry type and number of employees, and/or desired discussion topics.

11. Upcoming Connection Meeting invitations (on-line or via e-mail) recognize prior Experience Exchange groupings and allow group members to communicate with each other through linked e-mail and instant messaging.

12. Executive Business Exchange sessions are arranged and no-conflict among group participants is confirmed prior to Connection Meeting via technology as well as providing bios and detailed contact information on each session member. Survey data and post session questionnaire feedback are collected via PDA and archived, and new “Connections” identified during sessions (is my company a potential customer of yours, and/or my clients, my partners, and/or associates of mine) are added to relational database as well.

13. Senior executives from vendor companies can request specific targeted senior executives to have meals with them via developed technology, while targeted senior executives accept and confirm the same on-line or via e-mail when all tentative arrangements have been made.

14. User rights and permissions allow unique access to various levels of compiled and archived data and reports, as well as customizing the business directory views and communication capabilities with other members.

The foregoing description details certain embodiments of the invention. It will be appreciated, however, that no matter how detailed the foregoing appears, the invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes which come with the meaning and range of equivalency of the claims are to be embraced within their scope.

We claim:

1. A computer method of presenting a corporate introduction event, the method comprising:
obtaining attendee profile information data relating to a set of event attendees into a datastore;
processing the attendee profile information data and a set of sponsor information data such that a data processor produces a set of introduction meetings to take place between attendees and sponsors at the event; and
creating a schedule of meetings between event participants, wherein the event participants include event attendees and event sponsors, such that each event participant can receive real time schedule changes over a network communication.

2. A method as defined in claim 1, further including:
receiving desired changes to the schedule of meetings during the time of the event;
dynamically producing a changed schedule of meetings during the time of the event, in response to the received changes; and
providing the changed schedule to the event participants.

3. A method as defined in claim 1, wherein processing the attendee information comprises producing the set of introduction meetings in accordance with the profile information of attendees with respect to uncommitted business initiatives of the attendees.

4. A method as defined in claim 3, wherein the introduction meetings are further produced in accordance with company information identified from the attendee profile information to align uncommitted business initiatives of attendees with attendees affiliated with companies capable of satisfying the uncommitted business initiatives.

5. A method as defined in claim 1, further comprising:
providing a user interface that attendees can access via a network computer browser such that the user interface is adapted to reflect appropriate items based on the attendee profile information.

6. A method as defined in claim 1, further comprising automatically downloading a schedule of meetings for an individual attendee into a portable data processing device that is in network communication with the data processor and with one or more additional network email addresses of the individual attendee.

7. A method as defined in claim 6, wherein the portable data processing device of each individual attendee produces an alert message when a change is made to the schedule of meetings for the individual attendee and automatically solicits survey data from the individual attendee at the conclusion of each scheduled meeting for the individual attendee.

8. A method as defined in claim 6, wherein a schedule of the set of introduction meetings is stored in the network datastore and wherein the portable data processing device of each individual attendee communicates in real time over the network so as to exchange data in the datastore to propose changes, accept changes, and confirm changes to the set of introduction meetings related to the individual attendee.

9. A computer system that processes data for a corporate introduction event, the system comprising:
a datastore that contains attendee profile information data relating to a set of event attendees;
a system data processor that processes the attendee profile information data and a set of sponsor information data and produces a set of introduction meetings to take place between attendees and sponsors at the event, such that the data processor communicates over a communication network with one or more portable data processing devices that receive and display a schedule of meetings between event participants, wherein the event participants include event attendees and event sponsors, such that each event participant can receive real time schedule changes.

10. A system as defined in claim 9, wherein the system data processor receives desired changes to the schedule of meetings during the time of the event and dynamically produces a changed schedule of meetings during the time of the event, in response to the received changes, and provides the changed schedule to the portable data processing devices of the event participants over the communication network.

11. A system as defined in claim 9, wherein the system data processor produces the set of introduction meetings in accordance with the profile information of attendees with respect to uncommitted business initiatives of the attendees.

12. A system as defined in claim 11, wherein the system data processor produces the introduction meetings schedule in accordance with company information identified from the attendee profile information to align uncommitted business initiatives of attendees with attendees affiliated with companies capable of satisfying the uncommitted business initiatives.

13. A system as defined in claim 9, wherein the system data processor provides a user interface that attendees can access via a network computer browser such that the user interface is adapted to reflect appropriate items based on the attendee profile information.

14. A system as defined in claim 9, wherein the system data processor automatically pushes data comprising a schedule of meetings for an individual attendee into a portable data processing device that is in network communication with the data processor and also pushes the data to one or more additional network email addresses of the individual attendee.

15. A system as defined in claim 14, wherein the system data processor provides the portable data processing device of each individual attendee with changes to the schedule of meetings for the individual attendee, such that the portable data processing device can produce an alert message when a change to the schedule of meetings for the individual attendee is received and can automatically solicit survey data from the individual attendee at the conclusion of each scheduled meeting for the individual attendee.

16. A system as defined in claim 15, wherein a schedule of the set of introduction meetings is stored in the network datastore and wherein the system data processor exchanges communications in real time over the communication network from the portable data processing device of each individual attendee so as to exchange data in the datastore to propose changes, accept changes, and confirm changes to the set of introduction meetings related to the individual attendee.

17. A computer system that processes data for a corporate introduction event, the system comprising:
a datastore that contains attendee profile information data relating to persons who will be attendees at the event, wherein the attendee profile information of an attendee comprises data that relates to at least uncommitted business initiatives of the attendee, and attendee company affiliation, job title, geographic location, and industry;
a system data processor that processes the attendee profile information data and a set of sponsor information data that relates to sponsor companies and that identifies company affiliation, geographic location, and industry of the sponsor companies, such that the system data processor produces a set of introduction meetings between attendees and sponsors that are scheduled to take place at the event, in accordance with the profile information of the attendee to align uncommitted business initiatives of the attendee with other attendees who are affiliated with companies capable of satisfying the uncommitted business initiatives;
wherein the data processor communicates over a communication network with one or more portable data processing devices that receive and display a schedule of meetings between event participants, wherein the event participants include event attendees and event sponsors, such that each event participant can receive desired changes to the schedule of meetings during the time of the event;
wherein the system data processor dynamically produces a changed schedule of meetings during the time of the event, in response to the received changes, and provides the changed schedule to the portable data processing devices of the event participants over the communication network.

18. A system as defined in claim 9, wherein the system data processor provides a user interface that attendees can access via a network computer browser such that the user interface is adapted to display interface items based on the attendee profile information and otherwise prevents display of interface items not suited to the attendee profile information.

19. A system as defined in claim 17, wherein the system data processor automatically pushes data comprising a schedule of meetings for an individual attendee into a portable data processing device that is in network communication with the data processor and also pushes the data to one or more additional network email addresses of the individual attendee.

20. A system as defined in claim 19, wherein:
the system data processor sends data across the network connection to the portable data processing device of each individual attendee with changes to the schedule of meetings for the individual attendee, such that the portable data processing device can produce an alert message when it receives a change to the schedule of meetings for the individual attendee and can automatically solicit survey data from the individual attendee at the conclusion of each scheduled meeting for the individual attendee; and
the network datastore contains a schedule of the set of introduction meetings and the system data processor exchanges communications in real time over the communication network with the portable data processing device of each individual attendee so as to exchange data in the datastore to propose changes, accept changes, and confirm changes to the set of introduction meetings related to the individual attendee.
